(19) United States
(12) Patent Application Publication
(10) Pub. No.: US 2025/0256293 A1
(43) Pub. Date: Aug. 14, 2025

(54) AIR SOURCE CONTROL FOR AN AIR OPERATED FLUID SPRAYER

(71) Applicant: WAGNER SPRAY TECH CORPORATION, Plymouth, MN (US)

(72) Inventors: Alex Michael SPIERING, Buffalo, MN (US); Shawn Cameron JOHNSON, Milaca, MN (US); Jeffrey Scott JERDEE, Brooklyn Park, MN (US); Jonathon Henry ANDERSON, Lakeville, MN (US); Joseph W. KIEFFER, Chanhassen, MN (US); Gary W. Box, Golden Valley, MN (US)

(21) Appl. No.: 18/934,592

(22) Filed: Nov. 1, 2024

Related U.S. Application Data
(60) Provisional application No. 63/551,663, filed on Feb. 9, 2024.

(51) Int. Cl. B05B 7/24; B05B 12/00

(52) U.S. Cl. CPC B05B 7/2491; B05B 12/008

(57) ABSTRACT

A fluid spraying system includes an air source unit operable by a motor to output a flow of pressurized air along an airflow path to a spraying device configured to output a spray of a fluid. When an actuator of the spraying device is in an open position, at least a portion of the pressurized air is emitted through an air outlet. When the actuator of the spraying device is in a closed position, airflow through the air outlet is inhibited. A control system is configured to receive an indication of an air pressure in a vented area configured to vent air when the actuator is in the closed position, generate an indication that the actuator is the closed position or the open position based on the indication of the air pressure, and generate a motor control signal to control the motor of based on the indication.

### CROSS-REFERENCE TO RELATED APPLICATION

The present application is based on and claims the benefit of U.S. provisional patent application Ser. No. 63/551,663, filed Feb. 9, 2024, the contents of which are hereby incorporated by reference in their entirety.

### BACKGROUND

A fluid spraying system can be used by an operator to deliver a fluid from a fluid source to an application area. For example, a protective coating can be sprayed, or otherwise applied, by an applicator, such as a spray gun, to an application area, such as a surface of a wall.

The discussion above is merely provided for general background information and is not intended to be used as an aid in determining the scope of the claimed subject matter. The claimed subject matter is not limited to implementations that solve any or all noted disadvantages.

### SUMMARY

A fluid spraying system includes an air source unit operable by a motor to output a flow of pressurized air along an airflow path to a spraying device configured to output a spray of a fluid. When an actuator of the spraying device is in an open position, at least a portion of the pressurized air is emitted through an air outlet. When the actuator of the spraying device is in a closed position, airflow through the air outlet is inhibited. A control system is configured to receive an indication of an air pressure in a vented area configured to vent air when the actuator is in the closed position, generate an indication that the actuator is the closed position or the open position based on the indication of the air pressure, and generate a motor control signal to control the motor of based on the indication.

These and various other features and advantages will be apparent from a reading of the following Detailed Description. This Summary and Abstract are not intended to identify key features or essential features of the claimed subject matter, nor are they intended to be used as an aid in determining the scope of the claimed subject matter. The claimed subject matter is not limited to implementations that solve any or all noted disadvantages.

### BRIEF DESCRIPTION OF THE DRAWINGS

FIG. 1-1 is a diagrammatic view showing one example of an air-operated spraying system.

FIG. 1-2 is a perspective view of one example of an air source unit.

FIG. 2 is a schematic block diagram showing one example of an air-operated spraying system.

FIG. 3 is a flow diagram showing an example operation of motor speed control of an air source unit for a fluid sprayer.

FIG. 4 is a flow diagram showing an example operation of controlling motor speed of an air-operated fluid sprayer.

FIG. 5 is a flow diagram showing an example operation of controlling motor speed of an air-operated fluid sprayer.

FIGS. 6-1 and 6-2 (collectively referred to as FIG. 6) are diagrammatic and exploded views, respectively, showing one example of an air source unit control system for an air operated fluid sprayer.

FIGS. 7-1 and 7-2 (collectively referred to as FIG. 7) are cross-sectional views showing one example of an air source unit control system for an air operated fluid sprayer.

FIGS. 8-1 and 8-2 (collectively referred to as FIG. 8) illustrate one example of an air source unit control system for an air operated fluid sprayer.

FIG. 9 is a flow diagram illustrating one example of motor speed control for an air source unit.

FIG. 10 is a flow diagram illustrating one example of motor speed control for an air source unit.

FIG. 11 is a flow diagram illustrating one example of motor speed control for an air source unit.

FIG. 12 is a flow diagram illustrating an example of a process for motor speed control.

FIGS. 13-1 and 13-1 (collectively referred to as FIG. 13) provide a flow diagram illustrating an example of a process for motor speed control.

FIG. 14 is a perspective view of one example of an air source unit.

FIG. 15 is a cross-sectional view of the air source unit in FIG. 14 taken at line 15-15.

FIGS. 16-1 and 16-2 (collectively referred to as FIG. 16) is a flow diagram showing one example of an air source unit control system for an air operated fluid sprayer.

FIG. 17 is a graph illustrating detected air pressure over time for an example spray operation.

FIG. 18 is a derivative graph illustrating the rate of change of the detected air pressure in FIG. 17.

FIG. 19 is a graph illustrating detected air pressure over time for an example spray operation.

FIG. 20 is a derivative graph illustrating the rate of change of the detected air pressure in FIG. 19.

FIG. 21 is a graph illustrating detected air pressure over time for an example air source unit ramp down.

FIG. 22 is a derivative graph illustrating the rate of change of the detected air pressure in FIG. 21.

FIG. 23 is a graph illustrating detected air pressure over time for a spray operation during air source unit ramp down, in one example.

FIG. 24 is a derivative graph illustrating the rate of change of the detected air pressure in FIG. 23.

FIG. 25 is a second derivative graph illustrating changes in the rate of change of the detected air pressure in FIG. 23.

FIG. 26 is a block diagram showing one example of a computing environment that can be used in the architectures shown in the previous Figures.

While the above-identified figures set forth one or more examples of the disclosed subject matter, other examples are also contemplated, as noted in the disclosure. In all cases, this disclosure presents the disclosed subject matter by way of representation and not limitation. It should be understood that numerous other modifications and examples can be devised by those skilled in the art which fall within the scope and spirit of the principles of this disclosure.

### DETAILED DESCRIPTION

For the sake of illustration, but not by limitation, aspects of the present disclosure relate to air-operated fluid sprayers, sometimes referred to as pneumatic sprayers, that operate at least partially by air or gas pressure. For example, an air-operated fluid sprayer can utilize a flow of pressurized or compressed air from an air source unit to spray a liquid or other fluid, such as protective or decorative coatings, onto a surface. One example fluid includes paint.

As used herein, examples of paint include substances composed of coloring matter or pigment suspended in a liquid medium as well as substances that are free of coloring matter or pigment. Paint can also include preparatory coatings. Paint can be applied to coat a surface as a liquid or a gaseous suspension, for example, and the coating provided can be opaque, transparent, or semi-transparent. Some particular examples include, but are not limited to, latex paint, oil-based paint, stain, lacquers, varnish, inks, and the like.

While some examples are described herein in the context of applying paint, other types of fluid can be applied to surfaces, including, but not limited to, primer, lacquers, foams, textured materials, plural components, adhesive components, etc.

Additionally, while some examples below are illustrated in the context of air-operated sprayers such as, but not limited to, high-volume low pressure (HVLP) or low-volume low-pressure (LVLP) sprayers, it is expressly contemplated that the present features can also be applicable to other types of sprayers, etc.

An air-operated fluid sprayer can use a portable air turbine, air compressor, or other air source, to generate airflow from an air outlet of the air turbine through an air hose to a hand-held spray gun that is controlled by a trigger and uses the air to atomize the fluid. One example of an HVLP sprayer can operate at air pressures between one tenth and ten pounds per square inch (PSI) at the air nozzle and consume air volumes between six and thirty cubic feet per minute (CFM).

In some applications, an air turbine includes a motor that typically runs at a constant power regardless of whether fluid is being emitted from the spray gun, which can become increasingly taxing to both the energy supply and the fluid sprayer itself as the motor consistently runs at a higher power during operation of the air source. Additionally, due to the pressurized nature of the air source, it is difficult to implement motor control systems without compromising the integrity and functionality of the motor and spraying system.

Moreover, in such systems having air supplied from an air blower, when the spray gun is not triggered (e.g., the trigger is released, thereby shutting off atomization air), the motor can incur over-speeding and/or over-heating due to the blocked outlet. Not only can this cause increased jobsite noise which is undesirable to the user, this increase in motor speed and heat build-up can cause damage to electrical and/or mechanical parts of the sprayer. Increased heat can also cause abnormal or undesirable spattering on the application area due to over-heating or drying of the applied material.

Some approaches to mitigate such issues are to detect the airflow and to slow down the motor. However, such approaches often incorporate airflow restrictive mechanisms, such as check valve(s), in the airflow path downstream of the air turbine outlet (i.e., between the air turbine outlet and the spray gun) which operate to trap air pressure in the air hose. This trapped pressure can be measured to determine the operational state of the air source motor. However, these mechanism(s) add restriction in the airflow path resulting in a significant pressure drop, and this airflow restriction must be overcome during normal operation of the air source (e.g., by the air turbine having to run a higher speed and/or pressure to generate the same output at the spray gun).

The present disclosure is generally directed to a system for providing motor control for an air turbine, or other air source, in an air-operated fluid sprayer. In some described examples below, the motor control scheme is configured in a manner that is non-airflow restrictive. By “non-airflow restrictive” it is meant that any mechanisms, such as sensors and control devices, that are utilized for detecting operation of the sprayer (e.g., whether the trigger is pulled) for purposes of determining how to increase or decrease the speed of the motor, or make other operational changes, has substantially no restriction on the airflow between the outlet of the air turbine and the outlet of the sprayer, such as a spray nozzle on a handheld spray gun. Further, by “substantially” no restriction, it is meant that any restriction that may be imparted, if at all, results in less than one half pound per square inch (PSI) drop. In one example, the pressure drop is less than one quarter PSI.

Airflow resistance Rf (Pa·s/m3) can be defined as set forth in Equation 1 below.

$${R}_{f} = Δ p / {q}_{v} , \qquad ( Eq . l )$$

where Δp is the air pressure difference (referred to as differential pressure) with the respect to atmosphere (Pa), and qᵥ is the volumetric airflow rating (m3/s). The volumetric airflow rate is qᵥ=μS, where μ is the linear air velocity (m/s) and S is the cross-section area perpendicular to the direction of the flow (m²).

In at least one example discussed below, changes in air pressure at a vented area, such as a bleeder or exhaust port, are detected and used to determine whether air is flowing from the air nozzle, which can be utilized to speed up or slow down the motor driving the air source.

Alternatively, or in addition, aspects of the power supply, such as current flowing through the motor, the line voltage and/or, the line current, are measured and used to determine adjustments to the operating speed of the motor.

Alternatively, or in addition, an airflow sensor includes a movable element that reacts to the airflow in the air hose to the spray gun to indicate whether air is flowing through the air hose. While, in some examples, the cross-sectional area of the flow path can reduced by the placement of the movable sensor element in the airflow path, that cross-sectional area restriction is relatively small (e.g., placement of the sensor element results in a decrease in the cross-sectional area that is less than ten percent of the overall cross-sectional area), so as to have a negligible effect on the airflow through the airflow path to the spray gun.

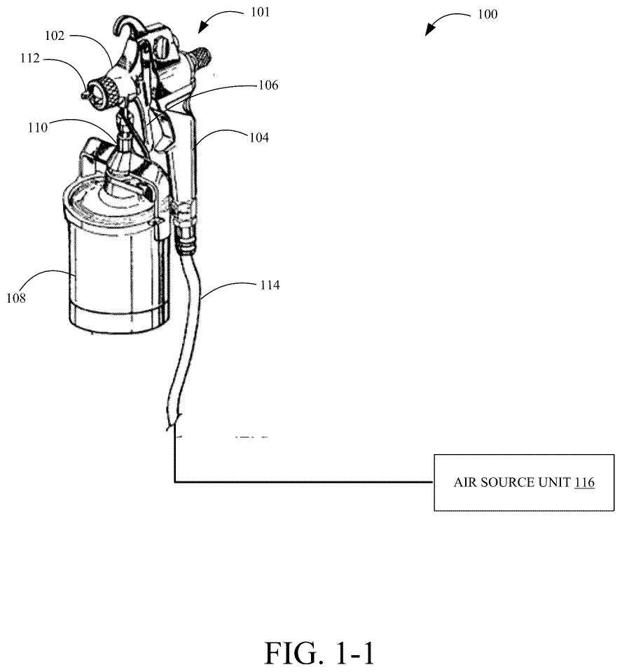

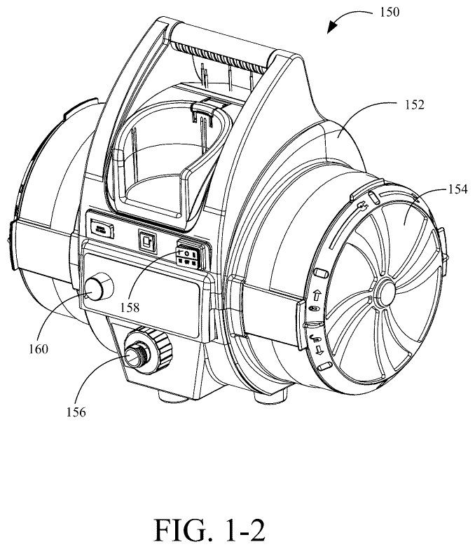

FIG. 1-1 is a diagrammatic view showing one example of an air-operated spraying system 100, also referred to as spraying system 100. Spraying system 100 includes a spray gun 101 having a body 102, a handle 104 and an actuator 106, illustratively in the form of a finger trigger, configured to operate a flow control mechanism, such as a valve (e.g., needle valve). However, in other examples, actuator 106 can include a button, a switch, or other type of actuator.

A fluid reservoir 108 is fluidically coupled to body 102 by a coupler 110 and configured to hold a fluid, such as paint, to be sprayed from a spray nozzle (or spray tip) 112. Spraying system 100 also includes a hose 114 coupled to an air source unit 116. Air source unit 116 is configured to generate airflow by drawing air into spraying system 100 through an air inlet and creating a pressured flow of air from an air hose outlet to which hose 114 is connected.

In one example, air source unit 116 can be an air turbine. However, it is expressly contemplated that other systems capable of producing airflow to spraying system 100 can be utilized as well.

In operation, the user actuates actuator 106 to open the flow control mechanism, thereby releasing the pressured air from hose 114, which causes atomization of the fluid from fluid reservoir 108, which is released from spray nozzle 112.

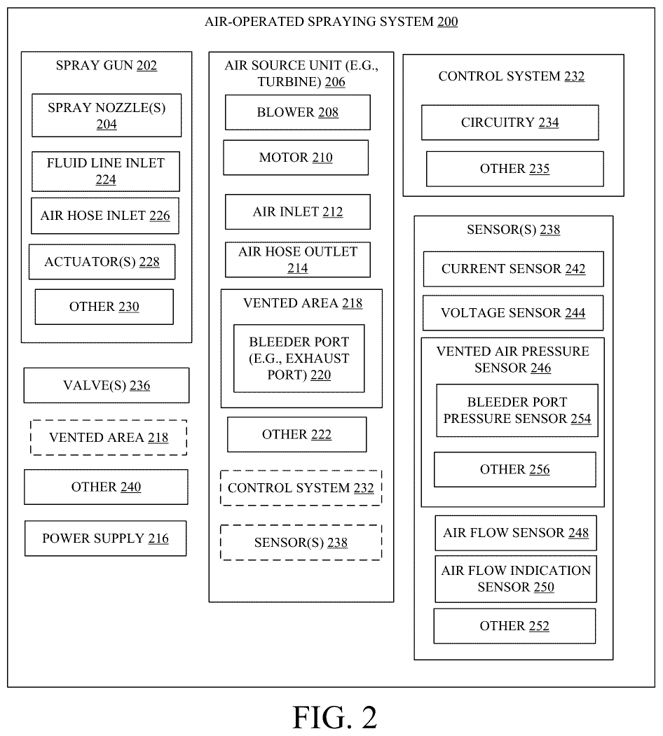

FIG. 1-2 is a perspective view of one example of an air source unit 150 (e.g., air source unit 116). Air source unit 150 includes a housing 152, an inlet 154, an airflow outlet fitting 156, a power control (i.e., on-off switch) 158, and a motor speed setting input mechanism 160. An electrical motor is housed within housing 152 and configured to operate on direct current or alternating current to drive a blower mechanism. A hose (e.g., hose 114) can be coupled to airflow outlet fitting 156 to supply the airflow to a spray gun or other spray apparatus.

The motor is controlled by control circuitry to operate the blower in a plurality of different modes depending on a detected configuration of the spray gun (e.g., whether or not the trigger is pulled to release airflow from the spray gun outlet). In one example, the blower is operated in a first low-speed or idle mode when the spray gun is closed (e.g., when the trigger of the spray gun is released) and thus no air is flowing through the spray gun. In this first mode, the speed of the turbine is non-zero (some air is being output by the blower), but since the spray gun is closed, the output air is vented through a vent area, such as a bleeder or exhaust port.

When an open or spraying configuration is detected (e.g., the user pulls the trigger to release airflow from the spray gun outlet), the blower is driven by the motor at a second high-speed or spraying mode). In one example, the speed at which the blower is driven in the second mode is set or adjusted by user input through mechanism 160.

Illustratively, mechanism 160 includes a dial that facilitates user selection of a desired speed setting from a plurality of speed settings. In one example, mechanism 160 adjusts a potentiometer which controls an amount of power supplied to the motor, and thus the speed at which the motor drives the blower. Thus, mechanism 160 controls the rate at which air is output through airflow outlet fitting 156.

The air can be compressed and accelerated by a fan, impeller, turbine, or other type of bladed mechanism that is rotated within housing 152 by the motor. The control circuitry can increase and decrease the power output of the motor by increasing and decreasing the power input to the motor.

FIG. 2 is a schematic block diagram showing one example of an air-operated spraying system 200 (e.g., spraying system 100), also referred to as spraying system 200. Spraying system 200 illustratively includes a spray gun 202 having one or more spray nozzles 204 with a spray orifice configured to emit an atomized spray pattern. The spray fluid can be, for example, paint. In one example, the spray fluid and air mix within a mixing chamber in spray gun 202, and are emitted from the spray orifice. Alternatively, or in addition, one or more air orifices can be disposed proximate the spray orifice to emit a stream of air that assists the spray of fluid from the spray orifice.

Spraying system 200 additionally includes an air source unit 206 (e.g., air source unit 116), such as an air turbine, that includes a blower 208 having a fan, impeller, or other type of bladed mechanism, that is driven by an electric motor 210 generate airflow by drawing air into spraying system 200 through an air inlet 212 and to output a flow of pressured air from an air hose outlet 214, in order to pressurize spraying system 200 and facilitate fluid flow out of spray nozzle 204. Motor 210 is powered by a power supply 216, such as a one hundred-twenty volt (V) alternating current (AC) power source. In another example, power supply 216 is a direct current (DC) power supply that powers a brushless DC motor (BLDC).

Air source unit 206 also includes a vented area 218 configured to vent at least a portion of the air, output by blower 208, away from the air hose outlet to a point external to spraying system 200. In one example, vented area 218 includes a bleeder or exhaust port 220 configured to release air to atmosphere. The amount of air bled through vented area 218 changes with restriction to airflow through air hose outlet 214 (i.e., whether or not air is being released from the spray gun 202). Air source unit 206 can include other items 222 as well.

As illustrated by the dashed block in FIG. 2, vented area 218 can be located in other locations in spraying system 200.

Spray gun 202 includes a fluid line inlet 224 configured to receive a flow of fluid to be sprayed and an air hose inlet 226 configured to receive the pressured air from the air hose. Spray gun 202 also includes one or more actuators 228, which are configured to allow fluid flow through nozzle 204. Actuator(s) 228 can include, for example, a trigger. However, in other examples, a different type of actuator can be used as well.

Spraying system 200 includes a control system 232 configured to control one or more components of spraying system 200, such as motor 210. Control system 232 can include circuitry 234. As illustrated by the dashed block in FIG. 2, one or more elements of control system 232 can be included in air source unit 206.

Power supply 216 is used to energize control system 232. In one example, power supply 216 can include a wired configuration. However, in another example, power supply 216 can be in a wireless configuration. Additionally, it is expressly contemplated that power supply 216 can include a different configuration as well.

Spraying system 200 also illustratively includes one or more valves 236, one or more sensors 238, and can include other items 240 as well. As illustrated by the dashed block in FIG. 2, one or more of sensor(s) 238 can be located in other areas as well.

Sensor(s) 238 can be coupled to control system 232 and any one or more of the other components in spraying system 200. For instance, sensor(s) 238 can be coupled to and configured to control air source unit 206, as further detailed below. In one example, controlling air source unit 206 can include lowering the speed of motor 210, as further discussed below. In another example, controlling air source unit 206 can include raising the speed of motor 210.

Sensor(s) 238 can include a current sensor 242, a voltage sensor 244, a vented air pressure sensor 246, an airflow sensor 248, an airflow indication sensor 250, and can include other sensors 252 as well.

In one example, current sensor 242 is configured to detect a magnitude and/or changes in the current flowing through motor 210. In one example, current sensor 242 is configured to sense the line current from power supply 216. Voltage sensor 244 is configured to detect a magnitude and/or changes in the voltage from power supply 216 (e.g., line voltage). Based on the detected current and/or voltage, control system 232 can responsively change the motor run speed to an associated setting. For example, current sensor 242 can detect a rise in current, indicating that a motor run speed is to be set too high. In another example, current sensor 242 can detect a decrease in current, indicating that a motor run speed is to be set too low. As discussed in further detail below, the changes in the current and/or the voltage can result from changes in the power draw of motor 210, which resulted from turbine speed changes caused by airflow changes when the user opens and closes the spray gun valve.

Vented air pressure sensor 246 is configured to detect changes in air pressure in vented area 218. In one example, sensor 246 includes a bleeder port pressure sensor 254 configured to detect changes in pressure at bleeder port 220, as airflow is bled from air source unit 206. Sensor 246 can include other sensors 256 as well.

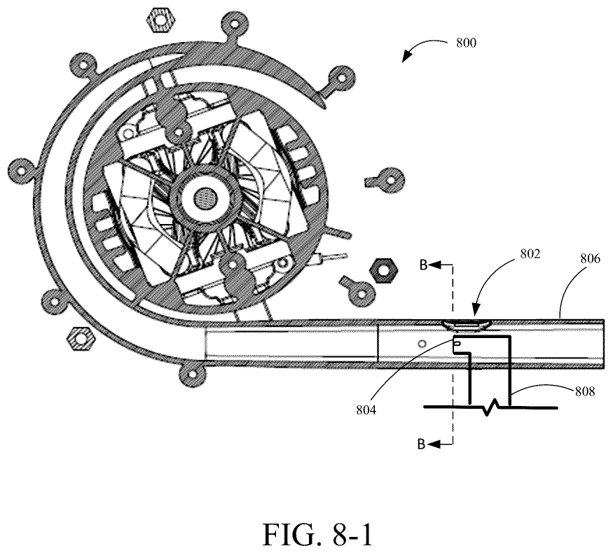

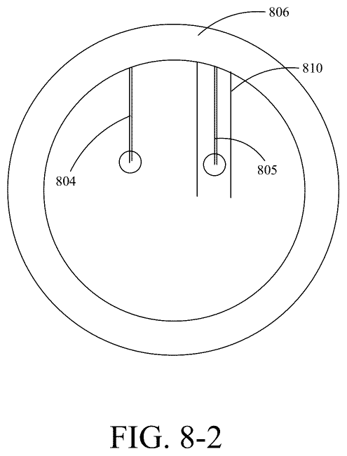

One example of airflow sensor 248 is described in further detail below with respect to FIG. 8. Airflow sensor 248 is configured to detect airflow through a flow tube of air source unit 206 and additionally detect any change in flow rate provided by air source unit 206 through the flow tube. In one example, airflow sensor 248 can include a hot wire anemometer. However, in another example, a different type of flow sensor can be utilized as well.

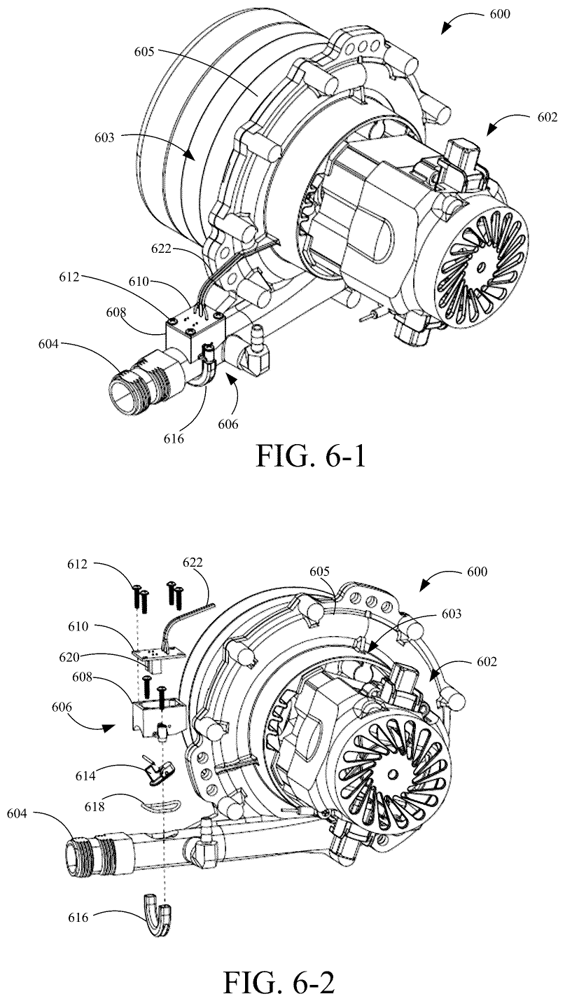

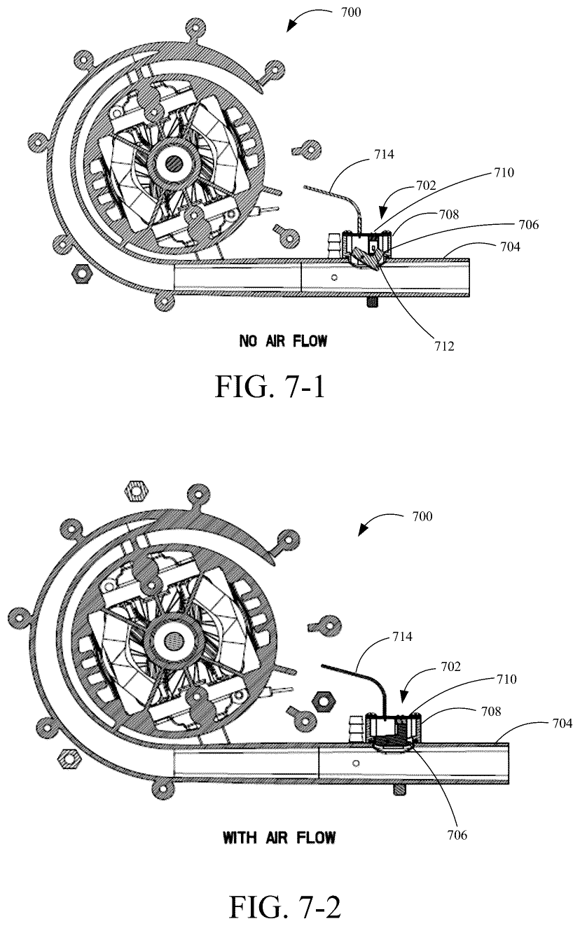

One example of airflow indication sensor 250 is described in further detail below with respect to FIGS. 6-7. In operation, as air is flowing through air source unit 206, a sensing element portion of airflow indication sensor 250 is biased into a position that engages with a corresponding sensing portion. When air is no longer flowing through air source unit 206, the sensing element portion disengages with the sensing portion, which generates a signal that is transmitted to control system 232, which determines that the motor speed should responsively decrease. Additionally, as air begins flowing through air source unit 206, the sensing element portion is once again biased to engage with the sensing portion, which generates a signal that is transmitted to control system 232, which determines that the motor speed should responsively increase.

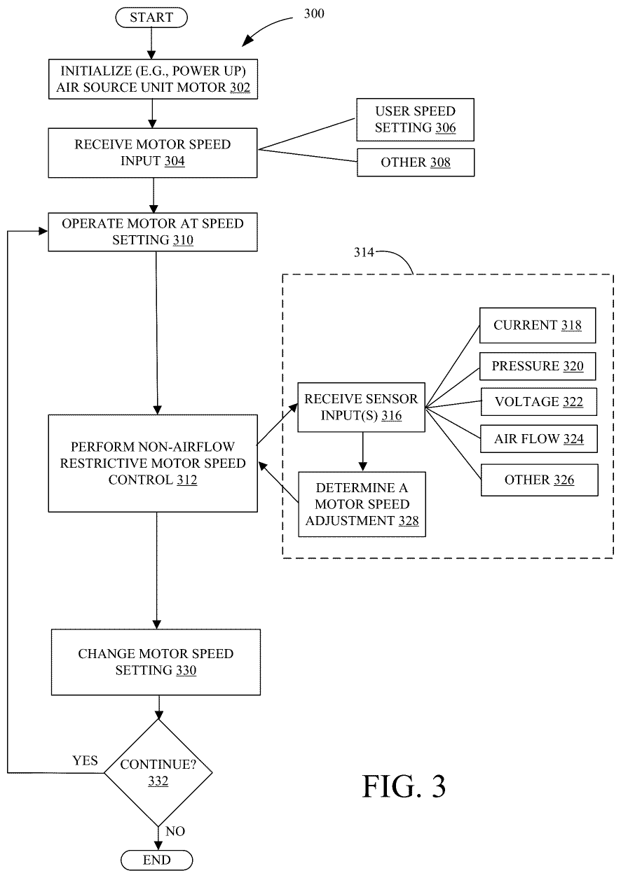

FIG. 3 is a flow diagram 300 showing one example of an operation for control of motor speed of an air source unit for a fluid sprayer. In one example, the operation illustrated in FIG. 3 is performed, at least in part, by control system 232 and is non-airflow restrictive.

As noted above, non-airflow restrictive refers to configurations in which the effect on the airflow, caused by any sensors or other devices that detect or otherwise control operation of the air source unit, between the outlet of the air source unit and the spray gun is such that there is substantially no restriction in airflow, and thus a reduced pressure drop, which improves performance of the spraying system.

For example, a non-airflow restrictive approach does not utilize check valve(s) (or other types of valves) to trap the pressure in the flow path between the outlet of the air source unit and the spray gun. As noted above, use of such a valve would restrict the airflow such that a significant pressure drop would result in the airflow across the check valve.

While FIG. 3 will be discussed in the context of an air turbine and a spray gun, other types of air sources and sprayers can be utilized. For sake of illustration, but not by limitation, FIG. 3 will be discussed in the context of FIG. 2.

At block 302, the motor 210 of air source unit 206 is initialized. Initialization can include a power up sequence in which the power supply 216 connects a source of power to motor 210 or motor 210 is otherwise energized. One example of a power supply is a one hundred twenty volt alternating current (AC) power source.

At block 304, a motor speed input is received. Block 304 can include a speed setting input by a user indicative of a desired pressure and/or flow rate for a target spraying operation, as represented at block 306. Of course, the motor speed input can be received in other ways as well, as represented at block 308.

At block 310, motor 210 is operated at the speed setting to drive the air source unit 206 to drive pressurized air from the air hose outlet 214 through an air hose to spray gun 202. An actuator 228, such as actuator 106 shown in FIG. 1-1, is actuatable by the user to open and close a valve in spray gun 202, which selectively opens and closes the airflow path. When the valve is open, airflows through the air hose (e.g. hose 114) and out of nozzle 204. When the valve is closed, airflow from nozzle 204 is blocked which stops the flow of airflow through the air hose. In some examples, the spray gun 202 can include an air bleed port which causes a small portion of air to be bled from the spray gun when the valve is closed.

Due to the slowing or stopping of the airflow through the air hose, motor 210 can tend to incur over-speeding and/or over-heating, due to the blocked air outlet. To mitigate the effects of an over-heating condition (and/or over-speeding), motor speed control is performed at block 312. In the illustrated example, the motor speed control is non-airflow restrictive as the motor speed control does not require mechanisms along the airflow path that restricts the airflow. Block 312 detects when the airflow path is blocked due to the user releasing the actuator of spray gun 202 and operates to decrease the motor speed to slow the air source. When the actuator of spray gun 202 is subsequently actuated by the user to open the valve and allow airflow through nozzle 204, block 312 detects this change and can operate to increase the speed of motor 210 and prevent an undesired significant pressure drop which would otherwise adversely affect the spray pattern.

One example of block 312 is illustrated in block 314. For example, at block 316, one or more sensor inputs are received from sensors 238. For example, the sensor input(s) can include a current sensor input (block 318) received from current sensor 242. Alternatively, or in addition, the sensor input(s) can include a pressure sensor input 320 from pressure sensor 246, such as a vented air pressure sensor 246, configured to measure the air pressure in vented area 218. For sake of illustration, when airflow from air hose outlet 214 is reduced, the airflow from bleeder port 220 increases, and this increase can be detected as an increase in pressure by sensor 238. Conversely, when airflow from air hose outlet 214 increases, a decrease in pressure can be detected at bleeder port 220.

Alternatively, or in addition, at block 322, a voltage sensor signal can be detected by a voltage sensor 244. Alternatively, or in addition, an airflow signal 324 can be detected by airflow sensor 248. Of course, other types of sensor inputs can be received as well, as represented at block 326.

At block 328, a motor speed adjustment is determined based on the sensor inputs received at block 316. The motor speed adjustment can indicate a desired increase or decrease to the motor speed (e.g., motor revolutions per minute-RPMs).

At block 330, the motor speed adjustment is utilized to change the motor speed setting. Operation can continue at block 332 in which the motor is operated at the current speed setting and motor speed control at block 312 can be performed based on any subsequent changes detected by sensors 238.

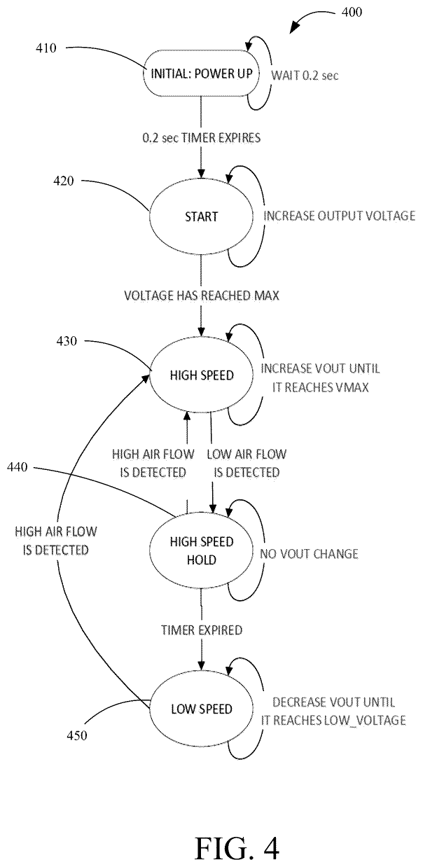

FIG. 4 is a flow diagram showing an example operation of controlling motor speed of an air-operated fluid sprayer. The motor speed control can be accomplished in a number of manners. For example, the motor speed can be controlled utilizing any one or more of the sensors described above with respect to FIG. 2. Operation 400 begins at block 410 where the air-operated fluid sprayer is powered up, or otherwise activated. The fluid sprayer can be powered up by, for example, a switch, a button, a power cable, or by any other method of supplying power to the fluid sprayer. As indicated at block 410, the initial power up phase can include idling for a preset time as the spraying system achieves full power. In one example, the idle time is about 0.2 seconds. However, in another example, a longer idle time can be implemented as well. Additionally, in another example, no idle time may be required.

The operation proceeds at block 420 where the idle time elapses and initial power-up phase of the air-operated fluid sprayer is completed. At block 420, the sprayer can be actuated or otherwise used to begin or resume a spraying job. Actuation of the fluid sprayer can be accomplished by, for example, using actuator 106 described above with respect to FIG. 1-1. As indicated at block 420, actuating or otherwise operating the fluid sprayer includes increasing the power to the electric motor of the fluid sprayer to a maximum.

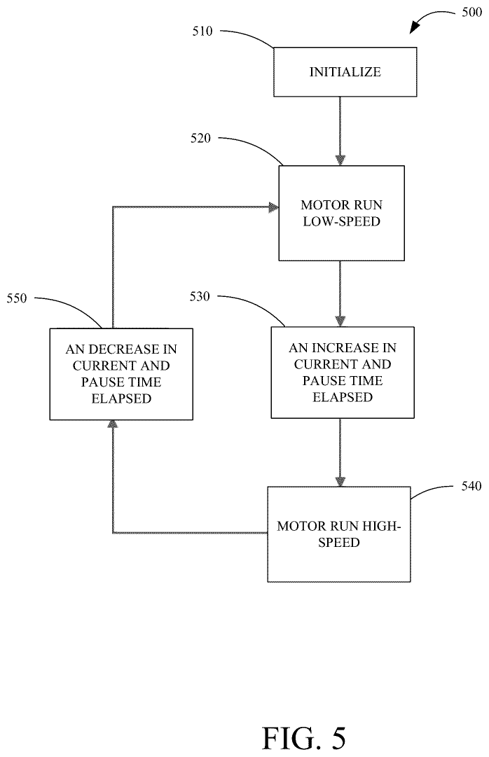

Upon reaching maximum power, the operation proceeds at block 430 where the motor of the air source unit (e.g., a turbine) is defined as a high speed. As indicated at block 430, if the motor was previously set to a lower speed, and therefore the output power was set to less than maximum, the output voltage is increased until returning to maximum power and defined high speed. As a decrease in airflow is detected, or low airflow is otherwise indicated, the operation proceeds at block 440 where the defined high speed is maintained for an idle period. As indicated above, the change in airflow can be detected by utilizing any one or more of the sensors described above with respect to FIG. 2 and further described below with respect to FIGS. 5-8. The decrease in airflow can occur, in one example, by releasing actuator 106 described above with respect to FIG. 1-1. The idle period is selected such that changes and/or modifications in the airflow provided by the air source unit (e.g., a turbine) can be detected. In one example, the idle period can be 10 seconds. In another example, the idle period can be 30 seconds. In another example, the idle period can be greater than 30 seconds. Additionally, in one example, the idle period can be manually set and/or modified by an operator of the spraying system.

As indicated in block 440, the output power of the spraying system does not change during the idle period, and the operation can proceed in two modes based on airflow detection. If an increase in airflow is detected within the idle period, the motor of the air source unit is signaled to maintain the motor's high speed and maximum power, and the idle period time resets. The increase in airflow can occur by, for example, actuation of the actuator of the spraying system. Alternatively, if the idle period expires with no detection of airflow change (e.g., the spraying system is not being actuated), the operation proceeds at block 450 where the motor is signaled to decrease to a defined low speed, and the output power of the spraying system responsively decreases to a low level relative to the maximum power. As indicated at block 450, if a change in airflow is detected that is indicative of an increase in airflow, the motor is signaled to increase to the defined high speed at block 430, and the output power of the spraying system responsively increases until the output power returns to a maximum. In this way, the motor speed can be controlled based on airflow detection of the air source unit relative to fluid sprayer use in real-time.

FIG. 5 is a flow diagram showing an example operation of controlling motor speed of an air-operated fluid sprayer. Operation 500 can be accomplished by, for example, utilizing a current sensor, as described above with respect to FIG. 2. Operation 500 begins at block 510 with initializing the air-operated fluid sprayer. Initializing the fluid sprayer can include, for example, powering up the spraying system similarly to block 410 described above with respect to FIG. 4.

The operation proceeds at block 520 where a motor of the air source unit is set to run at a defined speed relative to whether the spraying system is being operated or idle. For example, as shown at block 520, the motor is set at a defined low speed. However, it is expressly contemplated that the motor can alternatively be set to a defined high speed after initialization based on use of the spraying system. Upon detection of an increase in current consumed by the motor, the operation proceeds at block 530 where a timer having a predefined period begins based on the detected increase in current. The active period is selected such that changes and/or modifications in the current of the motor can be detected. Specifically, the active period is selected such that the current sensor senses the consistency of the current increase and/or whether the increased current is maintained, indicative of the spraying system being in continued use. In one example, the active period can be approximately 10 seconds. In another example, the active period can be greater than 10 seconds. In another example, the active period is less than 10 seconds (e.g., approximately 7 seconds). Additionally, in one example, the active period can be manually set and/or modified by an operator of the spraying system.

If the increase in current is maintained and the active period time elapses, the operation proceeds at block 540 where a signal is sent by the control system to the motor of the air source unit, causing the motor to switch to a defined high speed. The motor is configured to maintain the high-speed setting throughout continued use of the spraying system. Upon detection of a decrease in current consumed by the spraying system, the operation proceeds at block 550 where a timer having a predefined period begins based on the detected decrease in current. The idle period is selected such that changes and/or modifications in the current of the fluid sprayer (e.g., the motor) can be detected. Specifically, the idle period is selected such that the current sensor senses the consistency of the current decrease and/or whether the decreased current is maintained, indicative of spraying system use being discontinued. Upon the detection of the decrease in current and the idle time elapsing, the operation reverts to block 520, where the motor returns to the defined low speed.

FIGS. 6-1 and 6-2 (collectively referred to as FIG. 6) are diagrammatic and exploded views, respectively, showing one example of an air source unit control system for an air operated fluid sprayer. Air source unit 600 (illustratively a turbine) has an air inlet (not shown) and is configured to take in and compress air before delivering the compressed air at outlet 604. As shown, air source unit 600 is powered by electric motor 602 that drives a blower assembly 603 that includes a fan, impeller, turbine, or other type of bladed mechanism that is rotated within a housing 605.

In operation, air source unit 600 is coupled to a fluid sprayer at outlet 604 by a hose (not shown) and is configured to provide an airflow path for airflow through the hose and to the sprayer in order to pressurize the fluid sprayer and atomize the spray fluid. Air source unit 600 can be coupled to the hose in a number of configurations. For example, air source unit 600 can be threadably coupled to the hose. In another example, air source unit 600 can be coupled to the hose by a barbed fitting.

As shown in FIG. 6, air source unit 600 illustratively includes flow indication sensor 606 coupled to and disposed within the flow tube of air source unit 600 near outlet 604. Flow indication sensor 606 includes housing 608 and top portion 610 configured to secure the internal components of flow indication sensor 606 therein. Top portion 610 is coupled to housing 608 via fasteners 612. Additionally, housing 608 is coupled to the flow tube via one or more fasteners 612. As shown, fasteners 612 can include threaded fasteners, such as screws. However, it is expressly contemplated that other non-restrictive fasteners can be used as well, such as bolts.

Flow indication sensor 606 illustratively includes sensing element 614 configured to be retained within housing 608 and top portion 610. As further described below with respect to FIG. 6, sensing element 614 is configured to be disposed slightly within the top exterior of the flow tube. As shown in FIG. 6, sensing element 614 is configured to be secured to air source unit 600 by securing mechanism 616. Sensing element 614 has access to the interior of the flow tube via an aperture secured by aperture lining 618. By combining housing 608, top portion 610, fasteners 612, and aperture lining 618, sensing element 614 has access to airflow within the flow tube without compromising the pressurized environment of air source unit 600.

In operation, and further detailed below, sensing element 614 is configured to be secured within housing 608 and slightly sink into the flow tube when airflow is at a low flow rate and/or absent. Upon increasing flow rate within the flow tube, sensing element 614 is biased upwards out of the aperture defined by aperture lining 618 towards top portion 610 and within sensing portion 620. As shown in FIG. 6-2, sensing portion 620 includes a concave portion configured to allow sensing element 614 therethrough. As airflow biases sensing element 614 within the concave portion of sensing portion 620, a control signal is transmitted via wiring 622 to motor 602. The control signal can include, in one example, a signal to change the motor speed to a defined high speed. As airflow within the flow tube decreases and/or airflow is no longer present, sensing element 614 sinks slightly out of sensing portion 620 and into the flow tube. Upon sensing element 614 descending out of sensing portion 620, a control signal is transmitted via wiring 622 to the control system to cause motor 602 to change the motor speed to a defined low speed. In this way, the speed of motor 602 can be regulated relative to the level of airflow present within the flow tube at varying points of the spraying operation.

FIGS. 7-1 and 7-2 (collectively referred to as FIG. 7) are cross-sectional views showing one example of an air source unit control system for an air operated fluid sprayer. Air source unit 700 illustratively includes a flow indication sensor 702 coupled to flow tube 704. Flow indication sensor 702 includes sensing element 706 disposed within housing 708 and top portion 710. As shown in FIG. 7-1, sensing element 706 is disposed at a position slightly sunken into flow tube 704. As airflow within flow tube 704 increases, sensing element 706 is biased upwards towards sensing portion 712, as shown in FIG. 7-2. As sensing element 706 pivots towards sensing portion 712, a control signal is transmitted to the control system via wiring 714. As indicated above, the control signal can include, for example, a signal to change the motor speed to a defined high speed. As airflow diminishes within flow tube 704 relative to the use of air source unit 700, sensing element 706 descends from sensing portion 712 and sinks towards flow tube 704. The movement of sensing element 706 responsively causes a signal to be sent to the control system via wiring 714 to cause the control system to control the motor to change the motor speed to a defined low speed. Due to the contained nature of flow indication sensor 702, controlling the motor based on airflow is achievable while retaining the pressurized environment of the fluid sprayer.

FIGS. 8-1 and 8-2 (collectively referred to as FIG. 8) are cross-sectional views showing one example of an air source unit control system for an air operated fluid sprayer. FIG. 8-2 is a view taken at line B-B in FIG. 8-1.

As shown in FIG. 8, air source unit 800 illustratively includes flow sensor 802 generally disposed within flow tube 806. Flow sensor 802 includes a first hot wire anemometer 804 and a second hot wire anemometer 805. When air is flowing through flow tube 806, hot wire anemometer 804 operates by transferring heat from the wire to the airflow, thereby reducing the temperature of the wire portion of hot wire anemometer 804, corresponding to a change in resistance of hot wire anemometer 804 indicative of a measure of flow rate. Hot wire anemometer 805 is disposed within a plastic (or other suitable material) tube 810, which shields hot wire anemometer 805 from the airflow in flow tube 806.

As resistance of hot wire anemometer 804 changes, indicative of a change in airflow within flow tube 806, a signal is sent via wiring 808 to the control system to change the speed of the motor of the air source unit relative to the airflow. For example, if the airflow within flow tube 806 is low, indicative of a stall in operation of the fluid sprayer, hot wire anemometer 804 of flow sensor 802 increases in temperature, thereby changing the resistance of hot wire anemometer 804 and sending a control signal to the control system to cause the motor to change to a defined low speed based on the detected airflow. In another example, if airflow within flow tube 806 increases, indicative of continued operation of the fluid sprayer, hot wire anemometer 804 decreases in temperature, thereby changing the resistance of hot wire anemometer 804 and sending a corresponding control signal to cause the motor to change to a defined high speed.

Because hot wire anemometer 805 is shielded from the airflow, the temperature sensed by hot wire anemometer 805 is less effected by the airflow. In this way, the signal from hot wire anemometer 805 can be utilized as a control comparison, that is the signal from hot wire anemometer 805, indicating changes in temperature of hot wire anemometer 805, can be compared to the signal from hot wire anemometer 804 to determine the airflow rate. A signal indicative of the comparison can sent to the control system to control the motor of air source unit 800 based on the detected change in airflow.

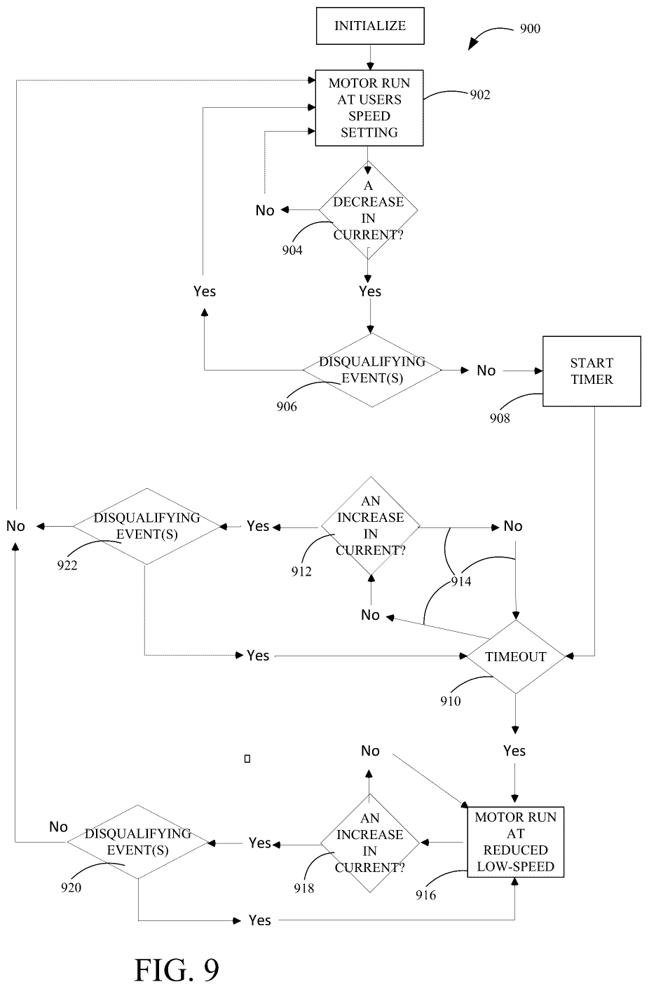

FIG. 9 is a flow diagram 900 illustrating one example of motor speed control performed at block 312.

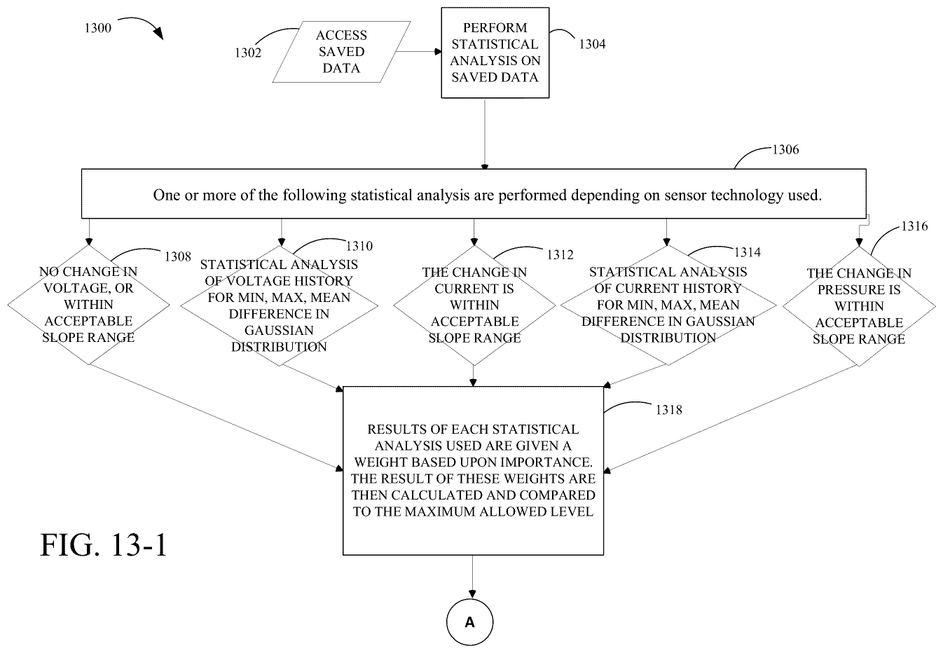

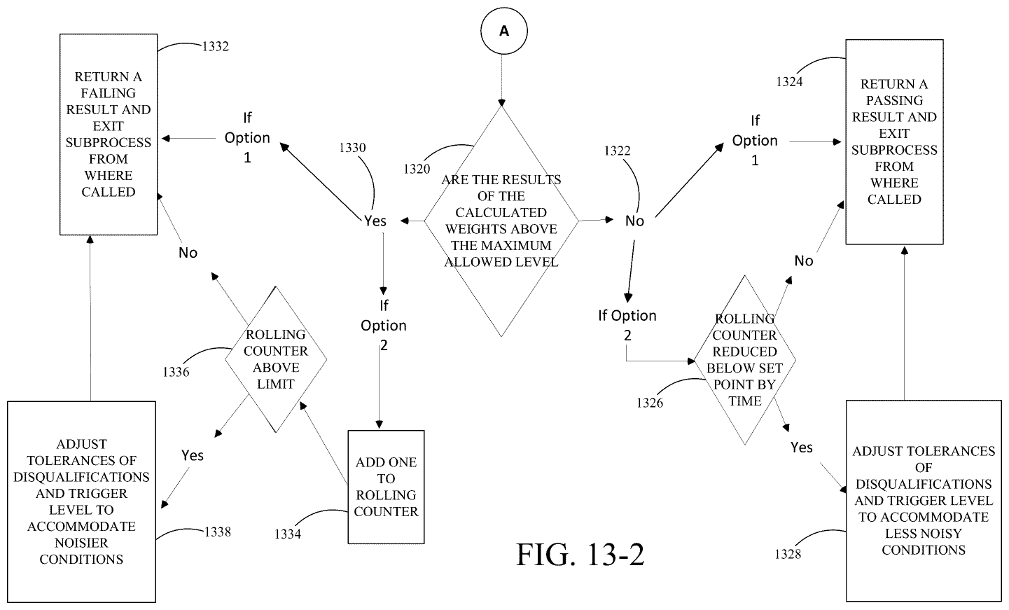

At block 902, motor 210 is operated at the user speed setting and, at block 904, a decrease in current is detected. In one example, block 904 detects that the current has decreased more than a threshold amount over a predefined time sampling window. If so, operation proceeds to block 906, which determines whether one or more disqualifying events have occurred. Examples of the detection of disqualifying events are discussed below with respect to FIG. 13. Briefly, however, a disqualifying event is used to determine whether a detected increase or decrease in current is to be ignored, such that there is no change to the motor speed setting. If a disqualifying event is detected, operation returns to block 902. Block 910 detects when the timer has expired, which is detected as a time-out event. Prior to the time-out event (represented by loop 914), block 912 determines whether or not an increase in current (e.g., more than a threshold increase in current over a defined time period) occurs. If no increase in current is detected, operation proceeds to block 916. At block 916, the motor is run at a reduced low-speed setting until an increase in current is detected at block 918. Upon this detection of the increase in current at block 918, operation proceeds to block 920 which detects one or more disqualifying events, as discussed above with respect to block 906.

Returning to block 912, if an increase in current is detected, operation proceeds to block 922. One example of detecting disqualifying events is discussed above with respect to block 906.

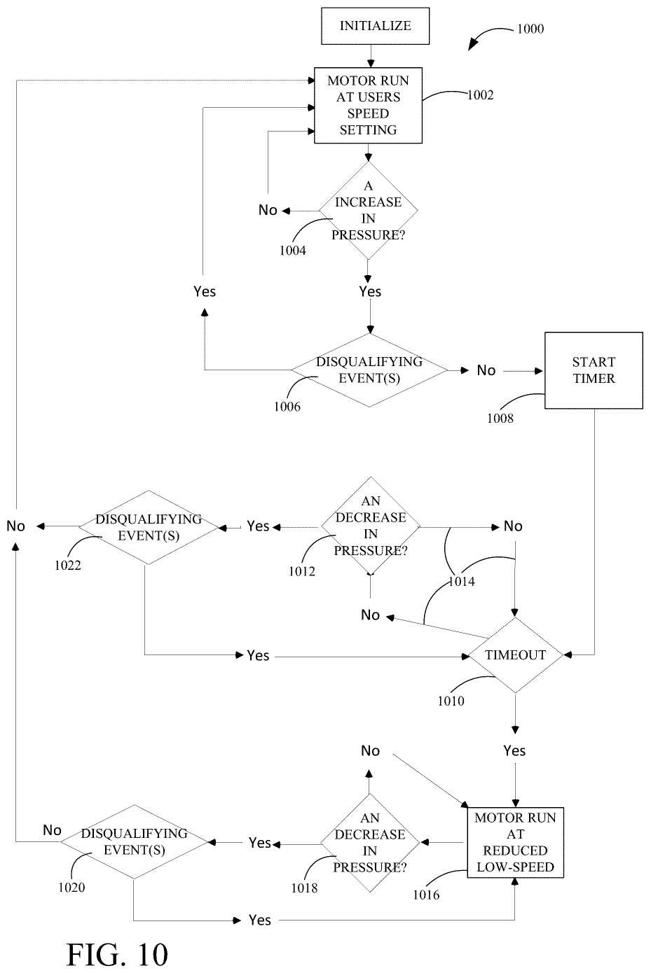

FIG. 10 is a flow diagram 1000 illustrating one example of motor speed control performed at block 312.

At block 1002, motor 210 is operated at the user speed setting and, at block 1004, an increase in pressure at the exhaust port of the air turbine is detected. In one example, block 1004 detects that the pressure has increased more than a threshold amount over a predefined time sampling window. If so, operation proceeds to block 1006, which determines whether one or more disqualifying events have occurred. Examples of the detection of disqualifying events are discussed below with respect to FIG. 13. Briefly, however, a disqualifying event is used to determine whether a detected increase or decrease in pressure is to be ignored, such that there is no change to the motor speed setting. If a disqualifying event is detected, operation returns to block 1002. Block 1010 detects when the timer has expired, which is detected as a time-out event. Prior to the time-out event (represented by loop 1014), block 1012 determines whether or not a decrease in pressure (e.g., more than a threshold decrease in pressure over a defined time period) occurs. If no decrease in pressure is detected, operation proceeds to block 1016. At block 1016, the motor is run at a reduced low-speed setting until a decrease in pressure is detected at block 1018. Upon this detection of the decrease in pressure at block 1018, operation proceeds to block 1020 which detects one or more disqualifying events, as discussed above with respect to block 1006.

Returning to block 1012, if a decrease in pressure is detected, operation proceeds to block 1022. One example of detecting disqualifying events is discussed above with respect to block 1006.

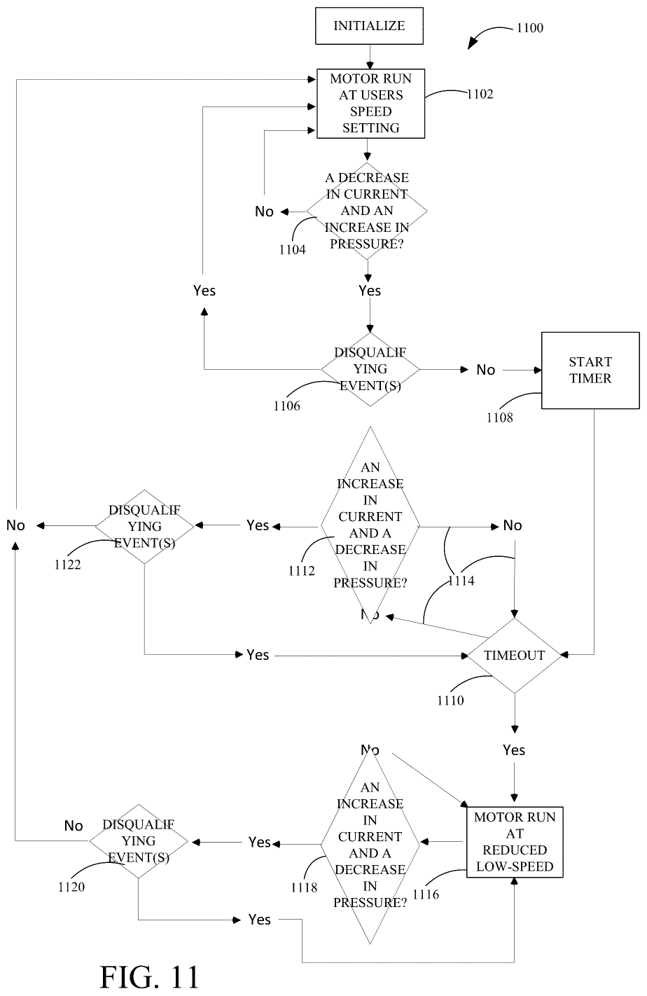

FIG. 11 is a flow diagram 1100 illustrating one example of motor speed control performed at block 312.

At block 1102, motor 210 is operated at the user speed setting and, at block 1104, a decrease in current is detected along with an increase in pressure at the exhaust port. In one example, block 1104 detects that the current has decreased more than a threshold amount over a predefined time sampling window. If so, operation proceeds to block 1106, which determines whether one or more disqualifying events have occurred. Examples of the detection of disqualifying events are discussed below with respect to FIG. 13. Briefly, however, a disqualifying event is used to determine whether a detected increase or decrease in current and/or pressure is to be ignored, such that there is no change to the motor speed setting. If a disqualifying event is detected, operation returns to block 1102. Block 1110 detects when the timer has expired, which is detected as a time-out event. Prior to the time-out event (represented by loop 1114), block 1112 determines whether or not an increase in current (e.g., more than a threshold increase in current over a defined time period) occurs along with a decrease in pressure at the exhaust port. If no increase/decrease is detected, operation proceeds to block 1116. At block 1116, the motor is run at a reduced low-speed setting until an increase in current is detected at block 1118. Upon this detection of at block 1118, operation proceeds to block 1120 which detects one or more disqualifying events, as discussed above with respect to block 1106.

Returning to block 1112, if an increase in current is detected along with a decrease in pressure at the exhaust port, operation proceeds to block 1122. One example of detecting disqualifying events is discussed above with respect to block 1106.

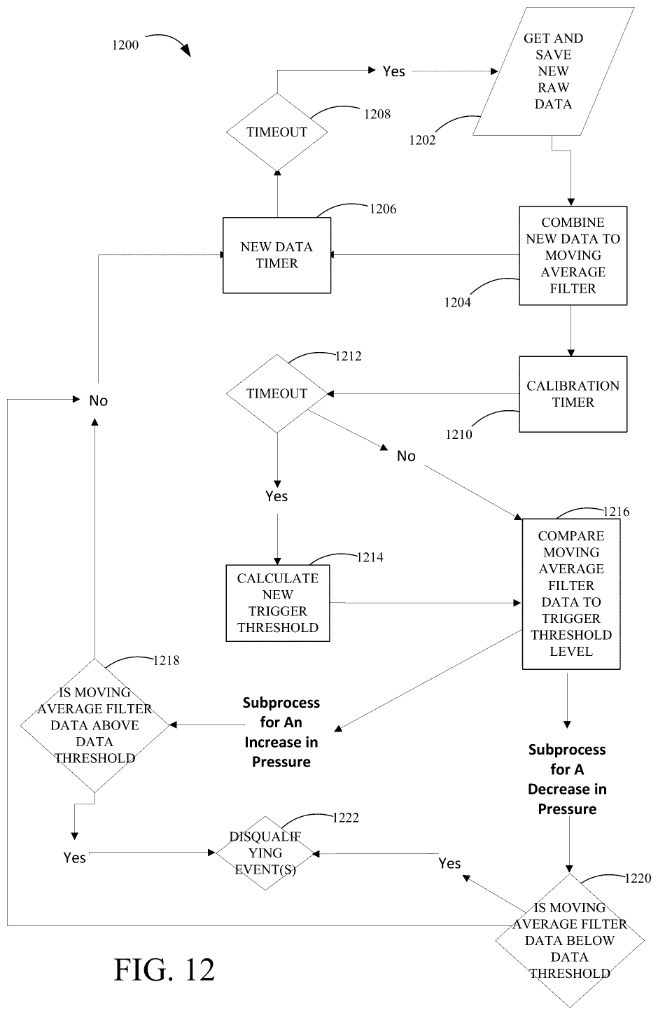

FIG. 12 is a flow diagram 1200 illustrating examples of subprocesses for an increase in pressure and a decrease in pressure.

At block 1202, the raw sensor data is obtained and used to create or update a moving average filter at block 1204. The raw data can represent the changes to pressure and/or current over time. A new data timer can be set at block 1206 after which a time-out event is identified at block 1208 and operation returns to block 1202 in which additional sensor data is obtained to adjust the moving average filter.

At block 1210, a calibration timer is set. Upon occurrence of expiration of the calibration timer (represented by block 1212), operation proceeds to block 1214 in which a new trigger threshold is calculated. However, prior to expiration of the time, the moving average filter data is compared to a trigger threshold level at block 1216. If this comparison indicates an increase in pressure, operation proceeds to block 1218. If an indication of a decrease in pressure is identified, operation proceeds to block 1220.

At block 1218, if the moving average filter data is above a data threshold, a disqualifying event subprocess is called at block 1222. Similarly, if the moving average filter data is below the data threshold at block 1220, the disqualifying event subprocesses is called as represented at block 1222.

At block 1218, if the moving average filter data is at or below the threshold level, the operation proceeds to block 1206 and waits for timeout at block 1208. Likewise, at block 1220, if the data is above or at the trigger threshold, the operation proceeds to block 1206 and waits for timeout at block 1208.

FIGS. 13-1 and 13-2 (collectively referred to as FIG. 13) provide a flow diagram 1300 illustrating one example of a disqualifying event subprocess. For example, the operation illustrated in FIG. 13 can be performed at one or more of blocks 906, 920, 922, 1006, 1020, 1022, 1106, 1120, and/or 1122.

At block 1302, saved sensor data is accessed and a statistical analysis is performed at block 1304. The type of statistical analysis performed can be selected based on the type of sensors used for sensing the operation (this is represented at block 1306).

For example, block 1308 determines whether there is no change in voltage or the change in voltage is within an acceptable slope range. Alternatively, or in addition, block 1310 includes a statistical analysis of a voltage history for a min, max, or mean difference in a Gaussian distribution. Alternatively, or in addition, block 1312 detects whether there is change in current within an acceptable slope range. Alternatively, or in addition, block 1314 performs a statistical analysis of a current history for a min, max, or mean difference in a Gaussian distribution. Alternatively, or in addition, block 1316 determines whether a change in pressure is within an acceptable slope range.

At block 1318, the results of each of the one or more statistical analyses that are used are assigned a weight based upon an importance metric. The weights can be identified and applied in any of a number of ways. In any case, the results of the weights are calculated and compared to a maximum allowed level.

At block 1320, operation determines whether the results of the calculated weights are above the maximum allowed level. If the result is below the maximum allowed level, operation proceeds to block 1322 which will be performed depending on whether or not adaptive triggering is utilized. If adaptive triggering is not being utilized, operation proceeds to block 1324 in which a passing result is returned and the subprocess of FIG. 13 is exited.

Adaptive triggering raises or lowers the trigger thresholds of voltage, current, and or pressure based on external line noise or environment changes. Furthermore, the weighted average from the disqualifications will be increased or decreased (less sensitive or more sensitive respectively) in the opposing direction of the triggering threshold change mentioned above.

If adaptative triggering is utilized, operation proceeds to block 1326 which determines whether a rolling counter is reduced below a set point. If so, operation proceeds to block 1328 in which tolerances of disqualifications and trigger level is adjusted to accommodate less noisy conditions.

If the results at block 1320 are above the maximum allowed level, operation proceeds to block 1330. If adaptive triggering is not being utilized, operation proceeds to block 1332. At block 1332, a failing result is returned and the subprocess is exited.

If adaptive triggering is utilized, operation proceeds to block 1334 in which a rolling counter is incremented. If the rolling counter exceeds a threshold, as identified at block 1336, the tolerances can be adjusted to accommodate noisier conditions.

The adjustments to the tolerances at blocks 1326 and 1338 can operate to account for noisy power supply conditions. For sake of illustration, but not by limitation, different power supplies may have different variations in current levels for a variety of reasons. Thus, the current and/or voltage sensors may detect more changes when one power supply is utilized versus another, regardless of the operation of the fluid sprayer. The process shown in FIG. 13 adjusts the tolerances to accommodate for these differences and learn the characteristics of the current power supply being utilized.

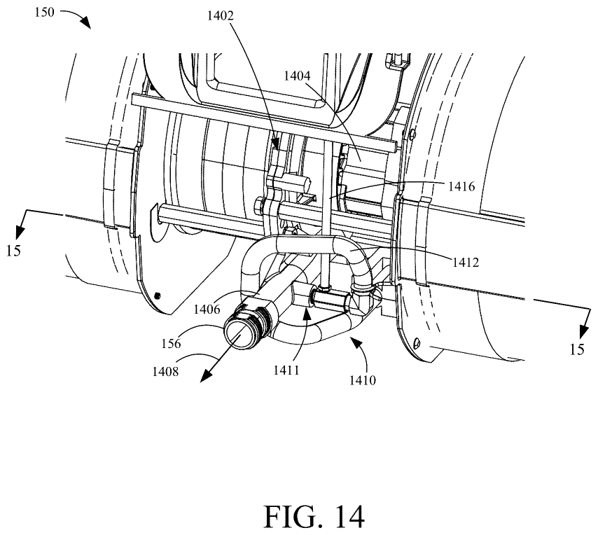

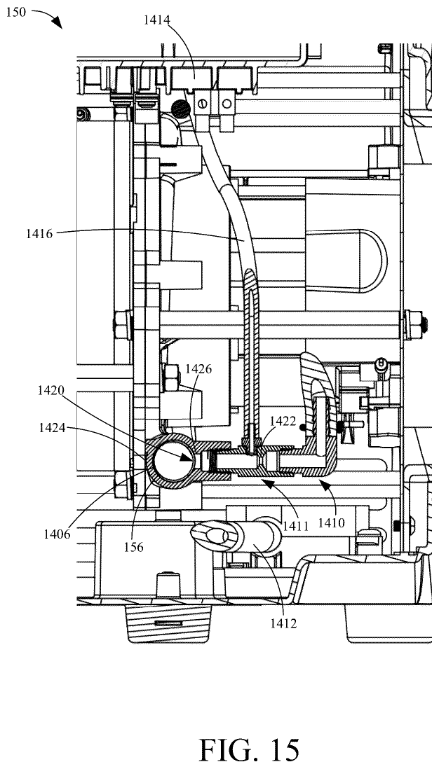

FIG. 14 is a perspective view of one example of air source unit 150 with a portion of housing 152 omitted for illustration purposes. FIG. 14 will be discussed in conjunction with FIG. 15, which is a cross-section view taken at line 15-15 in FIG. 14.

As shown, a motor 1402 is configured to drive rotation of a blower 1404 to provide a flow of air through a conduit 1406 having airflow outlet fitting 156. An air hose (e.g., hose 114) is coupled to airflow outlet fitting 156 which forms an airflow path to a spray gun or other applicator (e.g., spray gun 101). When the spray gun is actuated (e.g., a user pulls the trigger to release a mixture of the spray fluid and air), airflows in a downstream direction generally represented by arrow 1408 (also referred to as direction 1408). When the trigger is released (i.e., the spray gun is in a non-spraying configuration), airflow ceases in direction 1408.

Air source unit 150 includes a vented area 1410 configured to vent at least a portion of the airflow, generated by air source unit 150, to a point external to the air source unit (e.g., to atmosphere). Vented area 1410 illustratively includes at least a portion of conduit 1406 (e.g., an area in conduit 1406 upstream of airflow outlet fitting 156), a vent fitting 1411, and a vent conduit 1412 to a bleeder or exhaust port (not shown in FIG. 14) configured to release a portion of the air from blower 1404 to atmosphere. Air is vented through vented area 1410 both when air is being released from the spray gun (i.e., air is flowing in direction 1408) as well as when the spray gun is closed (i.e., there is no airflow in direction 1408). In this way, the flow rate and/or pressure in vented area 1410 fluctuates in response to opening and closing of the airflow path through the spray gun.

Air source unit 150 includes a vented air pressure sensor 1414 fluidically coupled to vented area 1410 by a conduit 1416. Illustratively, vented air pressure sensor 1414 is exposed to pressurized air in vented area 1410 by conduit 1416 branching from vent fitting 1411, and is configured to generate indication of the air pressure in vented area 1410. In the example of FIGS. 14 and 15, vented air pressure sensor 1414 is configured to detect the changes in pressure in a non-trapped air volume. That is, the air within vented area 1410 is not trapped within air source unit 150, even when the airflow path through the spray gun is closed. Further, this detection of changes in airflow along the airflow path to the spray gun is accomplished through a sensing and control scheme that is non-airflow restrictive.

As shown in FIG. 15, the flow path through vented area 1410 includes a first orifice 1420 having a first cross-sectional area and a second orifice 1422 having a second cross-sectional area. Conduit 1416 is fluidically coupled to vented area 1410 between orifices 1420 and 1422. In the illustrated example, the second cross-sectional area of orifice 1422 is smaller than a cross-sectional area of orifice 1420. The size of orifices 1420 and/or 1422 can be selected based on a desired air pressure sensing precision. In one example, orifice 1420 has a diameter of approximately one-quarter inch and orifice 1422 has a diameter of approximately one-eighth inch.

Further, it is noted that sensor 1414 can be fluidically coupled to vented area 1410 to sense the vented air pressure in other ways. For instance, in one example, sensor 1414 can be fluidically coupled directly to conduit 1406. In another example, sensor 1414 can be configured to detect air pressure in a chamber that is coupled to a side 1424 of conduit 1406 that is opposite a side 1426 on which the orifice 1420 for the bleeder port resides. In any case, sensor 1414 is configured to detect pressure changes in vented area 1410.

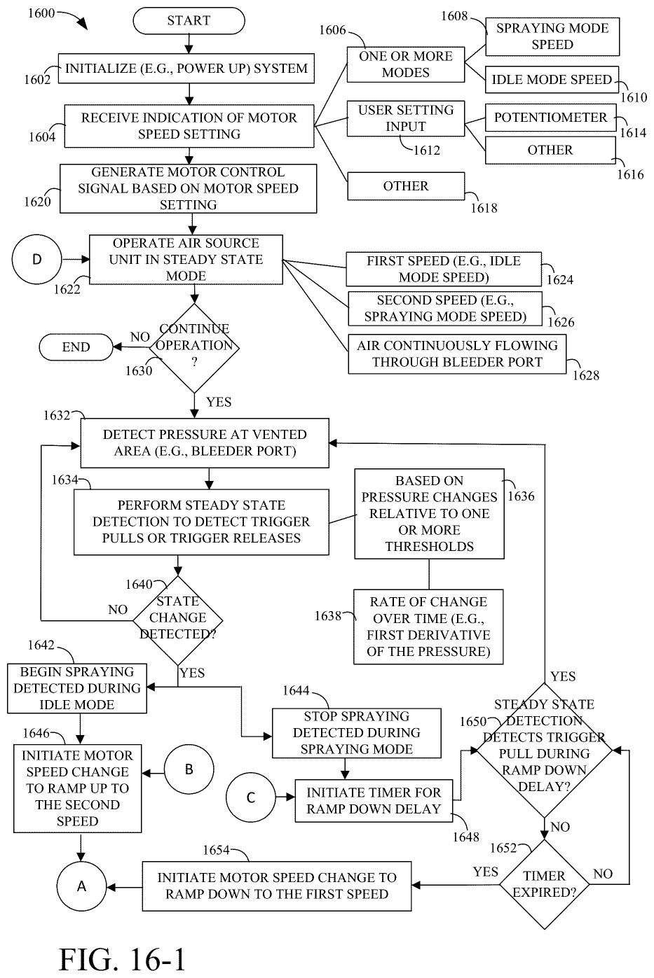

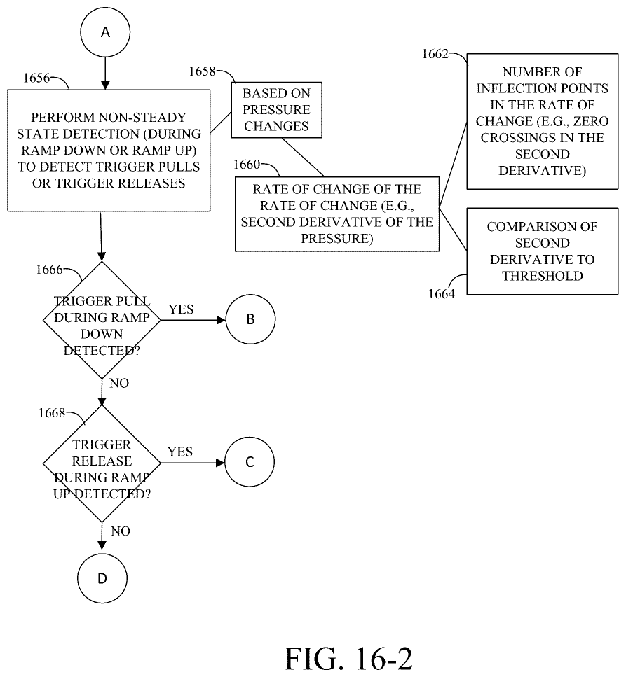

FIGS. 16-1 and 16-2 (collectively referred to as FIG. 16) is a flow diagram 1600 showing one example of motor speed control for an air source unit. Some or all features of flow diagram 1600 can be implemented by a control system, such as control system 232. For sake of illustration, but not by limitation, FIG. 16 will be discussed in the context of spraying system 200.

At block 1602, spraying system 200 is initialized, such as by powering up control system 232 (e.g., operably connecting spraying system 200 to a power source). At block 1604, control system 232 receives an indication of a motor speed setting. The motor speed setting can be defined for one or more operational modes. For example, a motor speed for motor 210 can be set for a spraying mode (block 1608). The spraying mode motor speed is used to control the speed at which motor 210 drives blower 208 when control system 232 detects that spray gun 202 is in an open position (e.g., trigger is pulled by the user). Also, a motor speed for motor 210 can be set for an idle mode (block 1610). The idle mode is illustratively a relatively lower speed mode, compared to the spraying mode, and is used to control the speed at which motor 210 drives blower 208 when spray gun 202 is in a closed position (e.g., fluid is not being sprayed). In one example, the motor speed for the idle mode is determined based on the motor speed setting for the spraying mode (e.g., the idle mode speed is a predetermined ratio of the spraying mode speed).

In one example, at block 1612, the motor speed setting is determined based on a user setting input, such as a potentiometer (block 1614) or other input mechanism (block 1616), which specifies the desired motor speed for the spraying mode. Of course, the motor speed setting can be set in other ways as well, as represented at block 1618.

At block 1620, control system 232 generates a motor control signal based on the detected mode and/or the motor speed setting. For instance, control system 232 operates the motor at a first, low or idle speed when spray gun 202 is not spraying and at a second, high or spraying speed when spray gun 202 is spraying.

At block 1622, air source unit 206 is operated in a steady state mode, in which spraying system 200 remains in one of the spraying mode or the idle mode. Accordingly, control system 232 operates motor 210 at the first speed (block 1624) or the second speed (block 1626). In either mode, air is continuously flowing through vented area 218, regardless of whether spray gun 202 is opened or closed, as represented at block 1628.

If operation continues at block 1630 (e.g., spraying system 200 remains powered on), at block 1632 an air pressure at vented area 218 is detected by vented air pressure sensor 246. Based on a sensor signal from vented air pressure sensor 246, control system 232 performs steady state detection at block 1634 to identify trigger pulls (or trigger releases) which start (or stop) the airflow through spray gun 202. In the illustrated example, the detection is based on air pressure changes in vented area 218 relative to one or more thresholds, as indicated at block 1636. For instance, in one example, a rate of change of the air pressure in vented area 218 over time is utilized to detect trigger pulls or trigger releases, which is represented by block 1638.

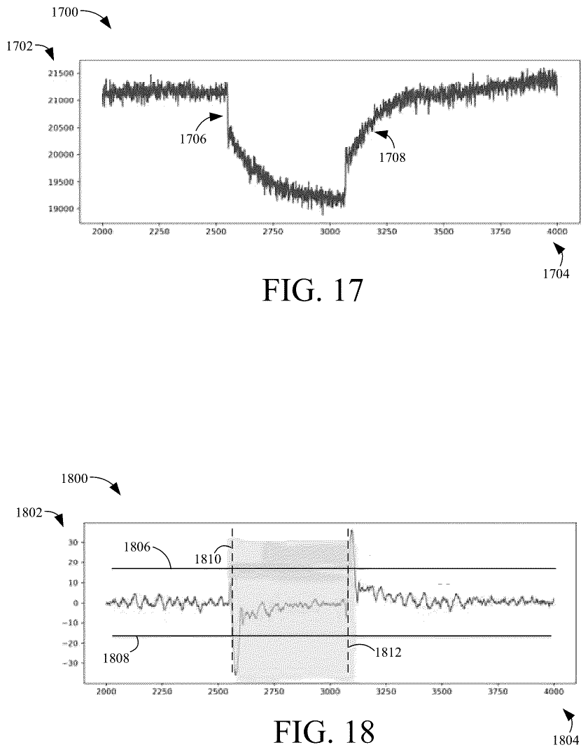

For sake of illustration, but not by limitation, FIG. 17 illustrates a graph 1700 representing a vented air pressure curve detected by sensor 246, in one example. FIG. 18 illustrates a graph 1800 representing the rate of change (or derivative) of the vented air pressure curve from FIG. 17. The derivative of the pressure curve represents the rate of change of pressure with respect to another variable, in this case, time. The derivative of pressure over time (dP/dt) describes how fast the pressure is changing over time. A positive derivative (dP/dt>0) indicates that pressure is increasing. A negative derivative (dP/dt<0) means pressure is decreasing. A zero derivative (dP/dt=0) indicates that pressure is constant.

In graph 1700, pressure is represented along the y-axis 1702 (in units of Pascals (Pa), or Newtons (N) per square meter) and time is represented along the x-axis in milliseconds (ms). As shown at reference numeral 1706, a drop in the vented air pressure occurs when the user pulls the trigger of spray gun 202. As shown at reference numeral 1708, when the trigger is released, the vented air pressure rises.

In graph 1800, the value of the derivative is represented on the y-axis 1802 and time is again represented on x-axis 1804. A first, positive, rate of change threshold is represented by line 1806 and a second, negative, rate of change threshold is represented by line 1808. When the derivative crosses the positive rate of change threshold, control system 232 determines that a positive spike in the pressure derivative has occurred, corresponding to a release of the trigger of spray gun 202 (i.e., a stop spraying condition). When the derivative crosses the negative rate of change threshold, control system 232 determines that a negative spike in the pressure derivative has occurred, corresponding to a pull of the trigger of spray gun 202 (i.e., a start spraying condition). In the example of FIG. 18, the shaded area between a time at which the negative rate of change threshold is crossed (represented by reference numeral 1810) and a time at which the positive rate of change threshold is crossed (represented by reference numeral 1812) is identified as a spraying operation in which the trigger is pulled and held open to release the spraying of fluid using the pressurized air.

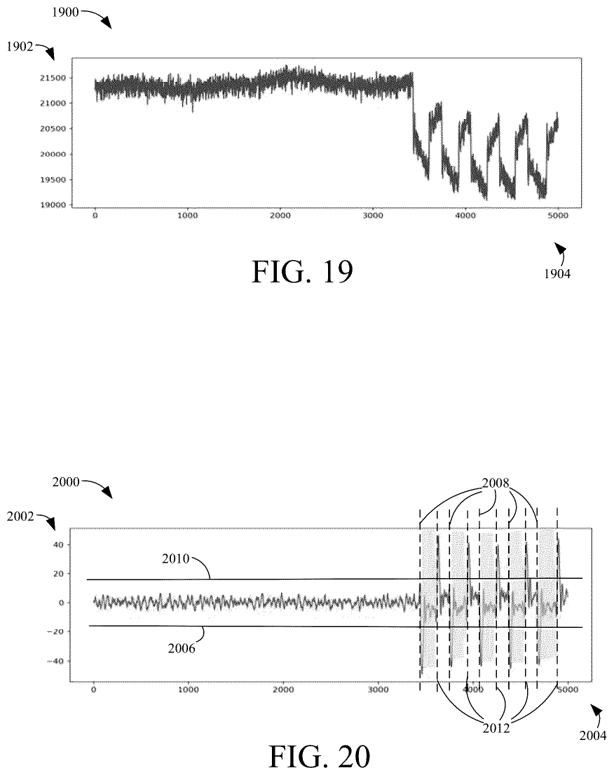

FIG. 19 illustrates a graph 1900 representing a vented air pressure curve detected by sensor 246, in one example of the user pulling and releasing the trigger multiple times. In FIG. 19, pressure is represented along the y-axis 19002 and time is represented along the x-axis 1904.

FIG. 20 illustrates a graph 2000 representing the rate of change of the vented air pressure curve from FIG. 19. In FIG. 20, the value of the derivative is represented on the y-axis 2002 and time is represented on the x-axis 2004.

As shown in FIG. 19, there are multiple drops in the vented air pressure, which correspond to points in the graph of FIG. 20 where the derivative crosses a negative rate of change threshold represented by line 2006. These points are represented by reference numeral 2008. Also, there are multiple spikes in the vented air pressure, which correspond to points in the graph of FIG. 20 where the derivative crosses a positive rate of change threshold represented by line 2010. These points are represented by reference numeral 2012.

As can be seen, in the described example, multiple trigger pulls in rapid succession can be detected even where the air pressure does not return to the steady state pressure in between temporally adjacent pulls.

Referring again to FIG. 16, at block 1640, control system 232 detects whether a state change has occurred based on the detection of trigger pulls or trigger releases at block 1634. If block 1640 detects that a begin or start spraying condition (i.e., the user pulls the trigger) occurs during the idle mode in which the motor is running at the low or idle speed, operation proceeds to block 1642. If block 1640 detects that a stop spraying condition (i.e., the user releases the trigger) occurs during the spraying mode in which the motor is running at the higher or spraying speed, operation proceeds to block 1644.

In response to the start spraying condition at block 1642, block 1646 initiates a motor speed change to ramp up the motor speed.

In response to the stop spraying condition at block 1644, block 1648 initiates a timer for a ramp down delay. The ramp down delay defines a time window, following release of the trigger, motor speed is slowed down. In one example, the ramp down delay is ten seconds, but this, of course, is for sake of example only. The ramp down delay can prevent undesired motor slowdowns between relatively short interval of trigger releases and trigger pulls.

At block 1650, control system 232 performs steady state detection of a trigger pull during the ramp down delay (i.e., before expiration of the timer and the motor speed is slowed). If a trigger pull is detected, operation returns the block 1632. If a trigger pull is not detected, operation proceeds in a loop (through block 1652) until the timer has expired. After the timer expires, operation proceeds the block 1654 in which the motor speed is ramped down to the first or idle speed.

At block 1656, non-steady state detection is performed during ramp up (from block 1646) or ramp down (from block 1654). During the non-steady state detection, trigger pulls or trigger releases are detected based on pressure changes at block 1658.

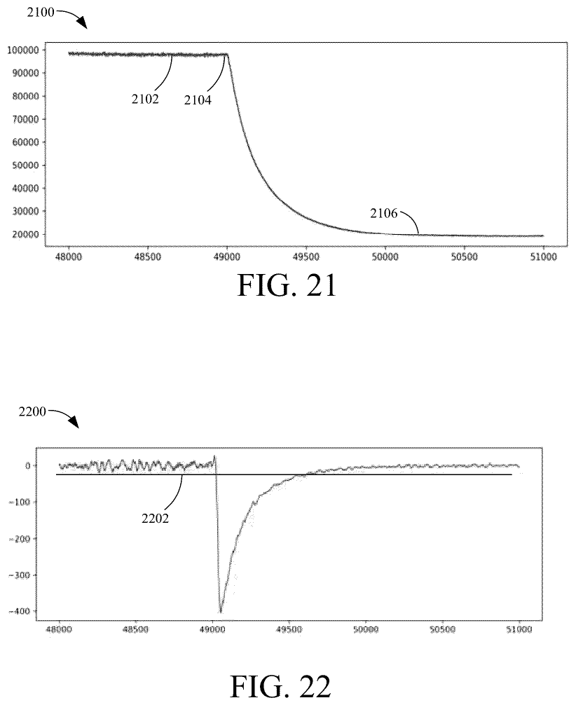

FIG. 21 illustrates a graph 2100 showing a pressure curve during air source ramp down when the user is not spraying, in one example. During the spraying mode, the air source unit is operated at a first pressure, which is detected as a first vented air pressure represented at reference numeral 2102. At a time represented by reference numeral 2104, the air source begins a ramp down which lowers the air source unit to a second pressure during an idle mode, represented at reference numeral 2106.

FIG. 22 illustrates a graph 2200 showing the derivative, or rate of change, of the pressure curve in graph 2100. As shown, there is a single large negative spike in dP/dT which cross a negative rate of change threshold 2202. However, in this example, the threshold cross is due to the air source unit ramp down, and not user actuation of the trigger. To distinguish pressure drops due to motor speed ramp down from pressure drops due to trigger actuation, block 1660 calculates the rate of change of the rate of change of the vented air pressure. Illustratively, block 1660 calculates the second derivative of the vented air pressure. The trigger pulls or trigger releases are detected, in one example, based on a number of inflection points in the rate of change (e.g., the number of zero crossings in the second derivative) (block 1662) and/or comparison of the second derivative to a threshold (block 1664).

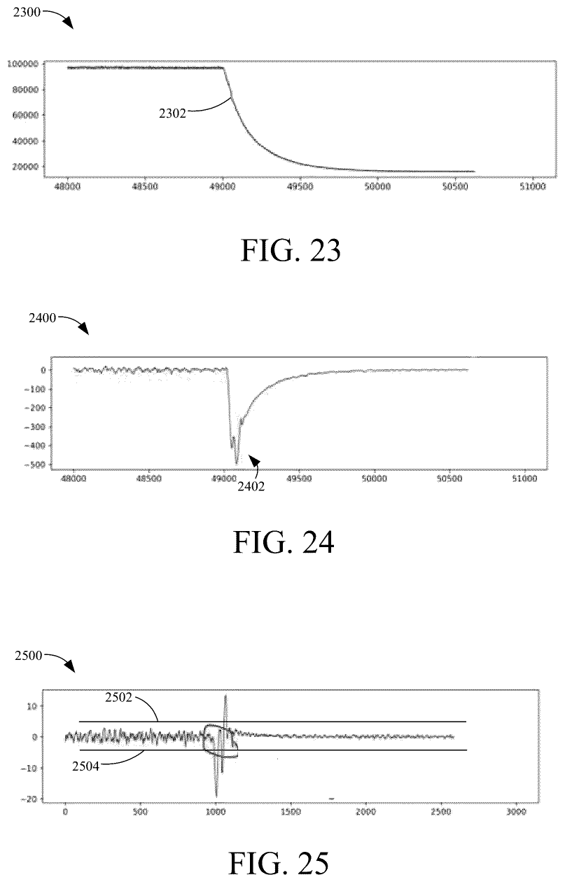

To illustrate, FIG. 23 illustrates a graph 2300 showing a pressure curve during air source ramp down when the user actuates the trigger to begin spraying, in one example. As can be seen, there is a slight change in inflection of the downward slope at reference 2302. FIG. 24 illustrates a graph 2400 showing the derivative, or rate of change, of the pressure curve in graph 2300. As can be seen at reference numeral 2402, the trigger pull during ramp down results in multiple peaks and valleys in the derivative (dP/dT). These inflection points in the rate of change can be seen in the second derivative graph 2300 shown in FIG. 25.

In one example, block 1660 identifies a number of instances in which the second derivative crosses zero after the second derivative value had met or exceeded one of an upper threshold 1502 or a lower threshold 1504 (referred to as “zero crossings”). If the number of zero crossings meets a count threshold (e.g., more than one), control system 232 determines that the trigger was pulled (or released, depending on whether the crossing occurred on the downward or upward slope of the first derivative).

Referring again to FIG. 16, at block 1666, the operation determines whether a trigger pull is detected during ramp down. If so, operation returns to block 1646. At block 1668, the operation determines whether a trigger release is detected during ramp up. If so, operation returns to block 1648.

It should also be noted that the different examples described herein can be combined in different ways. That is, parts of one or more examples can be combined with parts of one or more other examples. All of this is contemplated herein.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

The present discussion has mentioned processors and/or servers. In one embodiment, the processors and/or servers include computer processors with associated memory and timing circuitry, not separately shown. The processors and/or servers are functional parts of the systems or devices to which the processors and/or servers belong and are activated by and facilitate the functionality of the other components or items in those systems.

Also, the figures show a number of blocks with functionality ascribed to each block. It will be noted that fewer blocks can be used so the functionality is performed by fewer components. Also, more blocks can be used with the functionality distributed among more components.

As used herein, if a description includes “one or more of” or “at least one of” followed by a list of example features with a conjunction “or” between the penultimate example feature and the last example feature, then this is to be read such that (1) one example includes at least one of or one or more of each feature of the listed features, (2) another example includes at least one of or one or more of only one feature of the listed features, and (3) another example includes some combination of the listed features that is less than all of the features and more than one of the features.

As used herein, if a description includes “one or more of” or “at least one of” followed by a list of example features with a conjunction “and” between the penultimate example feature and the last example feature, then this is to be read such that the example includes at least one of or one or more of each feature of all the listed features.

As used herein, if a description includes “one or more of” or “at least one of” followed by a list of example features with a conjunction “and/or” between the penultimate example feature and the least example feature, then this is to be read such that, in one example, the description includes “one or more of” or “at least one of” followed by a list of example features with a conjunction “or” between the penultimate example feature and the last example feature, and, in another example, the description includes “one or more of” or “at least one of” followed by a list of example features with a conjunction “and” between the penultimate example feature and the last example feature.

It will be understood that the term exceeding with reference to a value exceeding a threshold value, as used herein, does not mean, in every example, that the value is greater than the threshold value. Rather, it will be understood that exceeding means that the value does not satisfy the threshold value, which can, in some examples, mean that the value is greater than the threshold value or, in other examples, can mean that the value is less than the threshold value. Also, in some examples, a threshold value can be a range of values and thus, exceeding means that the value does not satisfy the threshold value range (e.g., is outside of the range, whether higher or lower).

The above discussion has described a variety of different systems, components, logic, and interactions. One or more of these systems, components, logic and/or interactions can be implemented by hardware, such as processors, memory, or other processing components. Some particular examples include, but are not limited to, artificial intelligence components, such as neural networks, that perform the functions associated with those systems, components, logic, and/or interactions. In addition, the systems, components, logic and/or interactions can be implemented by software that is loaded into a memory and is executed by a processor, server, or other computing component, as described below. The systems, components, logic and/or interactions can also be implemented by different combinations of hardware, software, firmware, etc., some examples of which are described below. These are some examples of different structures that can be used to implement any or all of the systems, components, logic, and/or interactions described above.

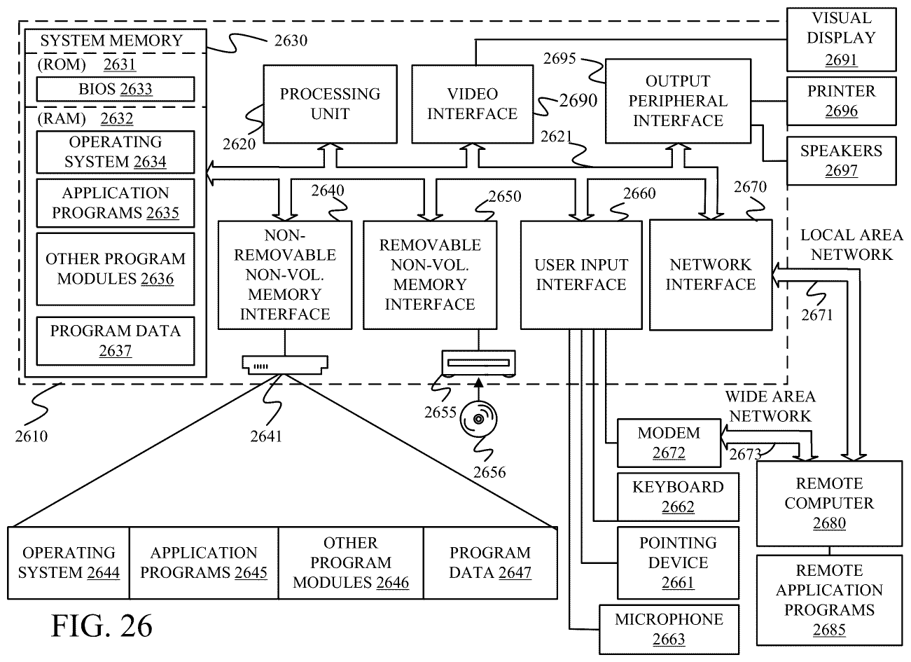

FIG. 26 is one example of a computing environment in which elements of the above figures, or parts of it, (for example) can be deployed. With reference to FIG. 26, an example system for implementing some embodiments includes a computing device in the form of a computer 2610. Components of computer 2610 may include, but are not limited to, a processing unit 2620 (which can comprise processors or servers from previous FIGS.), a system memory 2630, and a system bus 2621 that couples various system components including the system memory to the processing unit 2620. The system bus 2621 may be any of several types of bus structures including a memory bus or memory controller, a peripheral bus, and a local bus using any of a variety of bus architectures. Memory and programs, or other elements, described with respect to FIG. 2 can be deployed in corresponding portions of FIG. 26.

Computer 2610 typically includes a variety of computer readable media. Computer readable media can be any available media that can be accessed by computer 2610 and includes both volatile and nonvolatile media, removable and non-removable media. By way of example, and not limitation, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 2610. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 2630 includes computer storage media in the form of volatile and/or nonvolatile memory such as read only memory (ROM) 2631 and random-access memory (RAM) 2632. A basic input/output system 2633 (BIOS), containing the basic routines that help to transfer information between elements within computer 2610, such as during start-up, is typically stored in ROM 2631. RAM 2632 typically contains data and/or program modules that are immediately accessible to and/or presently being operated on by processing unit 2620. By way of example, and not limitation, FIG. 26 illustrates operating system 2634, application programs 2635, other program modules 2636, and program data 2637.

The computer 2610 may also include other removable/non-removable volatile/nonvolatile computer storage media. By way of example only, FIG. 26 illustrates a hard disk drive 2641 that reads from or writes to non-removable, nonvolatile magnetic media, an optical disk drive 2655, and nonvolatile optical disk 2656. The hard disk drive 2641 is typically connected to the system bus 2621 through a non-removable memory interface such as interface 2640, and optical disk drive 2655 is typically connected to the system bus 2621 by a removable memory interface, such as interface 2650.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 26, provide storage of computer readable instructions, data structures, program modules and other data for the computer 2610. In FIG. 26, for example, hard disk drive 2641 is illustrated as storing operating system 2644, application programs 2645, other program modules 2646, and program data 2647. Note that these components can either be the same as or different from operating system 2634, application programs 2635, other program modules 2636, and program data 2637.

A user may enter commands and information into the computer 2610 through input devices such as a keyboard 2662, a microphone 2663, and a pointing device 2661, such as a mouse, trackball or touch pad. Other input devices (not shown) may include a joystick, game pad, satellite dish, scanner, or the like. These and other input devices are often connected to the processing unit 2620 through a user input interface 2660 that is coupled to the system bus but may be connected by other interface and bus structures. A visual display 2691 or other type of display device is also connected to the system bus 2621 via an interface, such as a video interface 2690. In addition to the monitor, computers may also include other peripheral output devices such as speakers 2697 and printer 2696, which may be connected through an output peripheral interface 2695.

The computer 2610 is operated in a networked environment using logical connections (such as a local area network-LAN, or wide area network-WAN or a controller area network-CAN) to one or more remote computers, such as a remote computer 2680.

When used in a LAN networking environment, the computer 2610 is connected to the LAN 2671 through a network interface or adapter 2670. When used in a WAN networking environment, the computer 2610 typically includes a modem 2672 or other means for establishing communications over the WAN 2673, such as the Internet. In a networked environment, program modules may be stored in a remote memory storage device. FIG. 26 illustrates, for example, that remote application programs 2685 can reside on remote computer 2680.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts mentioned above are disclosed as example forms of implementing the claims. Workers skilled in the art will recognize that changes can be made in form and detail without departing from the spirit and scope of the invention.

What is claimed is:

1. A fluid spraying system comprising:
an air source unit operable by a motor to output a flow of pressurized air along an airflow path to a spraying device configured to output a spray of a fluid, the spraying device having an air outlet,
wherein, when an actuator of the spraying device is in an open position, at least a portion of the pressurized air is emitted through the air outlet, and, when the actuator of the spraying device is in a closed position, airflow through the air outlet is inhibited; and
a control system configured to:
receive an indication of an air pressure in a vented area, wherein the vented area is configured to vent air when the actuator of the spraying device is in the closed position;
generate an indication that the actuator of the spraying device is the closed position or the open position based on the indication of the air pressure; and
generate a motor control signal to control the motor of the air source unit based on the indication.

2. The fluid spraying system of claim 1, wherein a pressure drop of the airflow path between the air source unit and the spraying device is less than a one-half pound per square inch (PSI).

3. The fluid spraying system of claim 1, wherein
the indication comprises an air pressure signal from a vented air pressure sensor, and
the vented area is vented to atmosphere both when the actuator of the spraying device is in the closed position and when the actuator of the spraying device is in the open position.

4. The fluid spraying system of claim 3, wherein the vented area comprises a bleeder port.

5. The fluid spraying system of claim 1, wherein
the spraying device comprises a spray gun,
the air source unit comprises a blower,
the motor comprises an electrical motor, and
the control system is configured to control a speed of the motor by increasing or decreasing electrical power to the motor.

6. The fluid spraying system of claim 5, wherein the blower comprises at least one of a fan, an impeller, or a turbine that is rotatably driven by the motor to output the flow of pressurized air

7. The fluid spraying system of claim 1, wherein the actuator comprises a trigger configured to control a valve to actuate between the closed position and the open position to control the spray of the fluid using the pressurized air.

8. The fluid spraying system of claim 7, wherein
the indication indicates an actuation of the valve from the closed position to the open position that initiates the spray of the fluid using the pressurized air, and
the motor control signal defines an increase of a motor speed of the motor in response to the indication of the actuation of the valve.

9. The fluid spraying system of claim 7, wherein
the indication indicates an actuation of the valve from the open position to the closed position that stops the spray of the fluid, and
the motor control signal defines a decrease of a motor speed of the motor in response to the indication of the actuation of the valve.

10. The fluid spraying system of claim 9, wherein the motor speed is decreased after a predefined time delay following the indication of the actuation of the valve.

11. The fluid spraying system of claim 1, wherein the control system is configured to:
determine a rate of change of the air pressure in the vented area with respect to time; and
detect actuation of the actuator of the spraying device from the open position to the closed position based on a comparison of the rate of change to a rate of change threshold.

12. The fluid spraying system of claim 11, wherein the control system is configured to:
based on the actuation of the actuator of the spraying device from the open position to the closed position, generate the motor control signal to initiate a ramp down of a motor speed of the motor.

13. The fluid spraying system of claim 12, wherein the control system is configured to:
during the ramp down of the motor speed of the motor, detect an occurrence of one or more inflection points in the rate of change of the air pressure; and
based on the occurrence of the one or more inflection points, detect actuation of the actuator of the spraying device from the closed position to the open position during the ramp down, and, in response, increase the motor speed.

14. The fluid spraying system of claim 1, wherein the control system is configured to:
operate in a first control mode during a first time period in which a motor speed of the motor remains in a steady state; and
operate in a second control mode during a second time period in which the motor speed is increased or decreased.

15. The fluid spraying system of claim 14, wherein
the first control mode controls the motor speed based on a rate of change of the air pressure in the vented area; and
the second control mode controls the motor speed based on detected inflection points in the rate of change of the air pressure.

16. A method of controlling a fluid spraying system, the method comprising:
operating an air source unit to output an airflow, having a first airflow rate, along an airflow path to an outlet of the fluid spraying system to spray a fluid;
detecting a first spray condition that restricts the airflow through the outlet;
in response to the first spray condition, operating the air source unit to output the airflow at a second airflow rate that is less than the first airflow rate;
while the air source unit is operated to output the airflow at the second airflow rate, receiving one or more sensor signals indicative of one or more characteristics in a vented area of the fluid spraying system and detecting a second spray condition that resumes airflow through the outlet based on the one or more sensor signals; and
operating the air source unit to increase the airflow based on the detecting the second spray condition.

17. The method of claim 16, wherein the one or more characteristics comprises a vented air pressure in the vented area of the fluid spraying system.

18. The method of claim 17, and further comprising:
determining a rate of change of the vented air pressure with respect to time; and
detecting actuation of the fluid spraying system from an open position to a closed position based on a comparison of a rate of change of the vented air pressure to a rate of change threshold.

19. The method of claim 17, wherein the first spray condition comprises a cease spray condition in which the outlet is switched from an open configuration to a closed configuration, and the second spray condition comprises a start spray condition in which the outlet is switched from the closed configuration to the open configuration, the method comprises:
operating a motor of the air source unit at a first speed based on the cease spray condition, and
operating the motor of the air source unit at a second speed based on the start spray condition.

20. A fluid spraying system comprising:
an air source unit configured to provide airflow along an airflow path to a spraying device configured to output a spray of a fluid from a spray nozzle, wherein a pressure drop of the airflow path between the air source unit and the spraying device is less than a one-half pound per square inch (PSI).
a motor configured to drive the air source unit; and
a control system configured to:
receive one or more sensor signals indicative of an operation that changes the airflow along the airflow path; and
generate a motor control signal to control a motor speed of the motor based on the indication.

21. The fluid spraying system of claim 20, wherein the one or more sensor signals are indicative of at least one of:
a line current to the motor,
a line voltage to the motor,
an airflow in the airflow path, or
an air pressure in the airflow path.

22. The fluid spraying system of claim 20, wherein the control system is configured to:
detect a spraying condition indicative of a user operating the spraying device to begin the spray of the fluid from the spray nozzle based on detected changes in air pressure in a vented area of the fluid spraying system; and
generate the motor control signal to increase the motor speed of the motor based on the spraying condition.
